(19) United States
(12) Patent Application Publication
(10) Pub. No.: US 2014/0095745 A1
(43) Pub. Date: Apr. 3, 2014

(54) BUFFER DEVICE, BUFFER CONTROL DEVICE, AND BUFFER CONTROL METHOD

(71) Applicant: Fujitsu Limited, Kawasaki-shi (JP)

(72) Inventor: Jun KAWAHARA, Kawasaki (JP)

(73) Assignee: FUJITSU LIMITED, Kawasaki-shi (JP)

(21) Appl. No.: 14/095,370

(22) Filed: Dec. 3, 2013

Related U.S. Application Data
(63) Continuation of application No. PCT/JP2011/063214, filed on Jun. 9, 2011.

(51) Int. Cl. G06F 3/06

(52) U.S. Cl. CPC G06F 3/0656; G06F 3/061; G06F 3/0683
USPC 710/53

(57) ABSTRACT

A buffer device includes a plurality of input ports, a plurality of first in, first out (FIFO) buffers on which information input from the plurality of input ports is written, respectively, and at least one output port, an input switch unit that writes input information on a write target buffer selected from a predetermined buffer group based on information indicating a write position in the buffers of the buffer group and switches the write target buffer to another buffer in the buffer group according to the information indicating the write position, when the information is input from the input ports assigned to the predetermined buffer group among the plurality of buffers, and an output controller that reads information from a read target buffer selected based on information indicating a read position in the buffers of the buffer group and outputs the read information to the output port.

### CROSS-REFERENCE TO RELATED APPLICATION

This application is a continuation application of International Application PCT/JP2011/063214 filed on Jun. 9, 2011 and designated the U.S., the entire contents of which are incorporated herein by reference.

### FIELD

The present invention relates to a buffer device, a buffer control device, and a buffer control method in an information processing system.

### BACKGROUND

A buffer device which retains data input from a plurality of data paths and outputs the retained data from one port and which corresponds to multi-input and single-output illustrated in, for example, FIG. 16 is used in an information processing system in some cases.

FIG. 16 is a diagram illustrating an example of the configuration of a buffer device 200 corresponding to multi-input and single-output. FIGS. 17 and 18 are diagrams illustrating examples of the configurations of information processing systems 100-1 and 100-2 including a buffer device 200 exemplified in FIG. 16, respectively.

Note that, FIG. 16 illustrates the buffer device 200 corresponding to 3-input and 1-output. A direction of each arrow in FIGS. 17 and 18 indicates a data transmission direction. Note that, in FIGS. 17 and 18, the internal configuration of an XB 120-1 and parts of the configurations of buffer devices 200-1 to 200-4 of an XB 120-2 are not illustrated to simplify the drawings.

As exemplified in FIG. 16, the buffer device 200 includes buffers 500-1 to 500-3 configured in parallel for input ports 300-1 to 300-3, respectively. The buffers 500 store data input from the corresponding input ports 300-1 to 300-3 via input paths 300A to 300C, respectively. Hereinafter, when not distinguishing the buffers 500-1 to 500-3 from each other, the buffers 500-1 to 500-3 are simply referred to as the buffers 500. For example, volatile memories such as random access memories (RAMs) can be used as the buffers 500.

Based on an arbitration result of an arbitration unit 660, the buffer device 200 selects data to be output from the output target buffer 500 and outputs the data to an output path 700A. That is, the data read from the output target buffer 500 is output from the output port 700.

The buffer device 200 includes write control points 500a-1 to 500a-3 and read control pointers 500b-1 to 500b-3 in correspondence with the buffers 500, respectively. Hereinafter, when not distinguishing the write control pointers 500a-1 to 500a-3 and the read control pointers 500b-1 to 500b-3 from each other, the write control pointers 500a-1 to 500a-3 and the read control pointers 500b-1 to 500b-3 are referred to as the write control points 500a and the read control pointers 500b, respectively. The write control points 500a and the read control pointers 500b are indicated by WPs and RPs, respectively, in FIG. 16.

In the write control pointer 500a, a write address of the buffer 500 is recorded as a pointer value and input data to the buffer 500 is written at an address position indicated by the pointer value of the corresponding write control pointer 500a. Further, the write control pointer 500a increments the corresponding pointer value whenever input data is written on the corresponding buffer 500.

In the read control pointer 500b, a read address of output data from the buffer 500 is recorded as a pointer value and data stored in the buffer 500 is read from an address position indicated by a pointer value of the corresponding read control pointer 500b. Further, the read control pointer 500b increments its own pointer value whenever the output data is read from the corresponding buffer 500.

The arbitration unit 660 performs adjusting of a read timing of data from the buffer 500 and selects (adjusts) a read target buffer 500. The arbitration unit 660 outputs a control signal to select the read target buffer 500 as the arbitration result to a selector 630 at each read timing. Note that, the arbitration unit 660 selects the read target buffer 500 using, for example, a least recently used (LRU) scheme or a round-robin scheme.

The selector 630 reads the output data from the address position indicated by the pointer value of the read control pointer 500b corresponding to the read target buffer 500 based on the arbitration result obtained by the arbitration unit 660 and outputs the output data to the output path 700A.

Note that, for example, an information processing device such as a server, a system board (hereinafter, referred to as an SB), or the like is connected to the input ports 300-1 to 300-3 and the output port 700.

The buffer device 200 illustrated in FIG. 16 can be provided in, for example, a cross bar chip (hereinafter, referred to as an XB) or the like in the information processing system 100-1 illustrated in FIG. 17 or the information processing system 100-2 illustrated in FIG. 18.

In the example illustrated in FIG. 17, buffer devices 200-1 to 200-4 which each correspond to the buffer device 200 can be provided in an XB 120. Further, the output sides of the buffer devices 200-1 to 200-4, that is, the output ports 700, are connected to the corresponding SB 110-1 to SB 110-4 and the input sides of the buffer devices 200-1 to 200-4, that is, the input ports 300-1 to 300-3, are connected to the SB 110-1 to the SB 110-4 other than the corresponding SB.

The SB 110-1 to the SB 110-4 are connected so as to communicate with each other via each XB 120 by the buffer devices 200-1 to 200-4 exemplified in FIG. 17.

The information processing system 100-2 exemplified in FIG. 18 includes an XB 120-1 and an XB 120-2 connected so as to communicate with each other via a long distance transmission path. The XB 120-1 includes an SB 110-1 to an SB 110-3 connected so as to communicate with each other and the XB 120-2 includes an SB 110-4 to an SB 110-6 connected so as to communicate with each other.

In the example illustrated in FIG. 18, the XB 120-2 includes buffer devices 200-1 to 200-4 which each correspond to the buffer device 200, as in the XB 120 illustrated in FIG. 17. Note that, the XB 120-1 is not illustrated in FIG. 18, but has the same configuration as the XB 120-2 or the XB 120 illustrated in FIG. 17.

As exemplified in FIG. 18, an output side of the buffer device 200-1 of the XB 120-2 is connected to the XB 120-1 via the long distance transmission path and the output sides of the buffer devices 200-2 to 200-4 are connected to the corresponding SB 110-4 to SB 110-6. On the other hand, the input side of the buffer device 200-1 of the XB 120-2 is connected to each of the SB 110-4 to the SB 110-6. Further, the input sides of the buffer devices 200-2 to 200-4 of the XB 120-2 are connected to the XB 120-1 via the SB 110-4 to the SB 110-6 other than the corresponding SB and the long distance transmission path.

In the information processing system 100-2 exemplified in FIG. 18, the SB 110-1 to the SB 110-3 and the SB 110-4 to the SB 110-6 are connected so as to communicate with each other via the XB 120-1, the long distance transmission path, and the XB 120-2, as in the information processing system 100-1.

Note that, as a related technology, there is a technology in which an empty FIFO (First In, First Out) queue storing an empty FIFO number is provided, and an empty FIFO number is read from the empty FIFO queue to a write pointer to perform writing on an empty FIFO when a capacity disappears in an FIFO indicated by the write pointer.
[Patent Literature 1] Japanese Laid-open Patent Publication No. 5-336153

In transmission of data such as a packet, the capacity of a reception buffer is considerably influenced by a transmission distance.

For example, as a method of preventing a reception buffer from overflowing, a method is used in which the reception buffer or a reception-side device connected to the reception buffer transmits a busy signal to a transmission-side device. When the transmission-side device receives the busy signal, the transmission-side device inhibits data from being transmitted. However, as a transmission distance is longer, it takes more time until the transmission-side device receives the busy signal after the transmission of the busy signal. Therefore, it takes some time until the transmission-side device inhibits data from being transmitted.

Accordingly, a reception buffer used to transmit data is desired to save more data, in other words, to store more data as a transmission distance is longer. That is, ensuring the capacity of a reception buffer used for long distance transmission can be said to be one of the important tasks in long distance transmission.

Note that, as a method of ensuring the capacity of a reception buffer, a technique for providing the above-described empty FIFO queue storing the empty FIFO number can be exemplified.

In the technique for providing the empty FIFO queue, however, a writing unit writes a dedicated flag or an empty FIFO number on the inside of the FIFO performing writing until now, when using the empty FIFO. Therefore, data manipulation is to be performed in order for data to be written on the FIFO. Further, the writing unit or a reading unit may rewrite a write pointer or a read pointer based on a buffer number and presence or absence of the dedicated flag at the time of writing or reading.

Thus, in the technique for providing the empty FIFO queue, control relevant to switch of a write or read FIFO may be scarcely said to be a simple control.

Hitherto, the case has been described in which the plurality of buffer devices are provided in the XB and a plurality of information processing devices, SBs, or the like are connected via the XB so as to communicate with each other. However, the same problems may occur even when a plurality of information processing devices, SBs, or the like are connected via one buffer device so as to communicate with each other.

### SUMMARY

According to an aspect of the invention, a buffer device including: a plurality of input ports; a plurality of buffers on which information input from the plurality of input ports are written, respectively, each of the plurality of buffers is a first in, first out (FIFO) buffer; at least one output port from which information read from the buffers is output; an input switch unit that writes input information on a write target buffer selected from a predetermined buffer group based on information indicating a write position in the buffers of the buffer group and switches the write target buffer to another buffer in the buffer group according to the information indicating the write position, when the information is input from the input ports assigned to the buffer group among the plurality of buffers; and an output controller that reads information from a read target buffer selected based on information indicating a read position in the buffers of the buffer group and outputs the read information to the output port, and the input switch unit includes a first pointer that retains a first pointer value indicating the write position; a second pointer that retains a second pointer value changed according to the first pointer value; and a first switch unit that switches the write target buffer to the other buffer according to the change in the second pointer value and writes the information input from the input port on the write position indicated by the first pointer value in the switched write target buffer.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating an example of the configuration of a buffer device according to an embodiment;

FIG. 2 is a diagram illustrating an example of a detailed configuration of the buffer device according to the embodiment;

FIG. 3 is a flowchart illustrating an initial setting order of a normal operation and a joint operation performed by the buffer device according to the embodiment;

FIG. 4 is a flowchart illustrating an example of a process in the joint operation performed by an input controller of the buffer device according to the embodiment;

FIG. 5 is a flowchart illustrating an example of a process in the joint operation performed by an output controller of the buffer device according to the embodiment;

FIG. 6 is a diagram illustrating an example of a process in the joint operation of the buffer device illustrated in FIG. 2;

FIG. 7 is a diagram illustrating an example of the configuration of an information processing system according to the embodiment;

FIG. 8 is a diagram illustrating the configuration of the buffer device according to a modification example of an embodiment;

FIG. 9 is a diagram illustrating an example of path selection in a comparison circuit of the buffer device according to the modification example;

FIG. 10 is a diagram illustrating an example of path selection in the comparison circuit of the buffer device according to the modification example;

FIG. 11 is a flowchart illustrating an initial setting order of a normal operation and a joint operation performed by the buffer device according to the modification example;

FIG. 12 is a flowchart illustrating an example of a process in the joint operation performed by an input controller of the buffer device according to the modification example;

FIG. 13 is a flowchart illustrating an example of a process in the joint operation performed by an output controller of the buffer device according to the modification example;

FIG. 14 is a diagram illustrating an example of a process in the joint operation of the buffer device illustrated in FIG. 8;

FIG. 15 is a diagram illustrating an example of a process in the joint operation of the buffer device illustrated in FIG. 8;

FIG. 16 is a diagram illustrating an example of the configuration of a buffer device corresponding to multi-input and single-output;

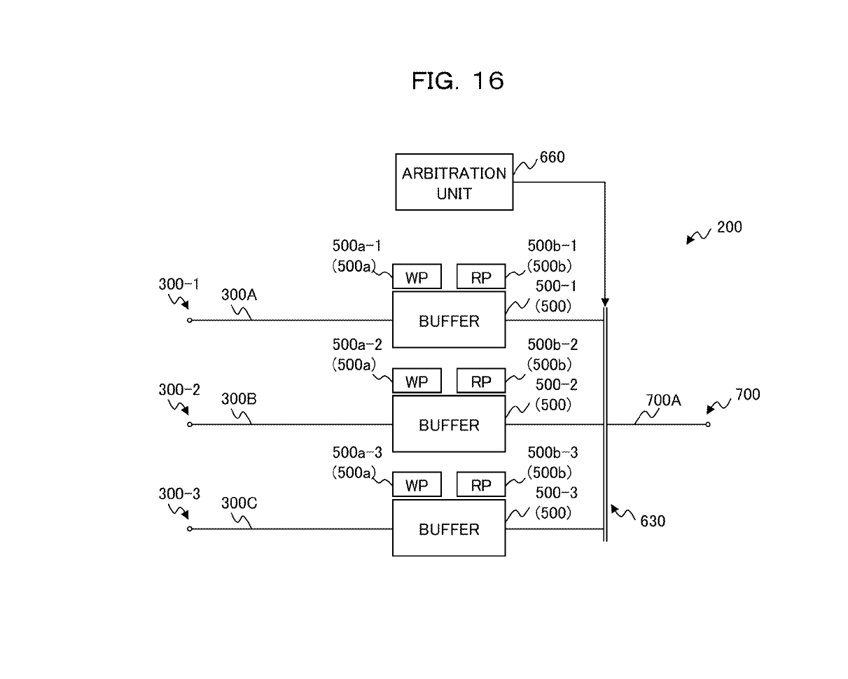

FIG. 17 is a diagram illustrating an example of the configuration of an information processing system including the buffer device exemplified in FIG. 16; and

FIG. 18 is a diagram illustrating an example of the configuration of an information processing system including the buffer device exemplified in FIG. 16.

### DESCRIPTION OF THE PREFERRED EMBODIMENTS

Hereinafter, an embodiment of the present disclosure will be described with reference to the drawings.

### [1] Embodiment

[1-1] Configuration of Embodiment

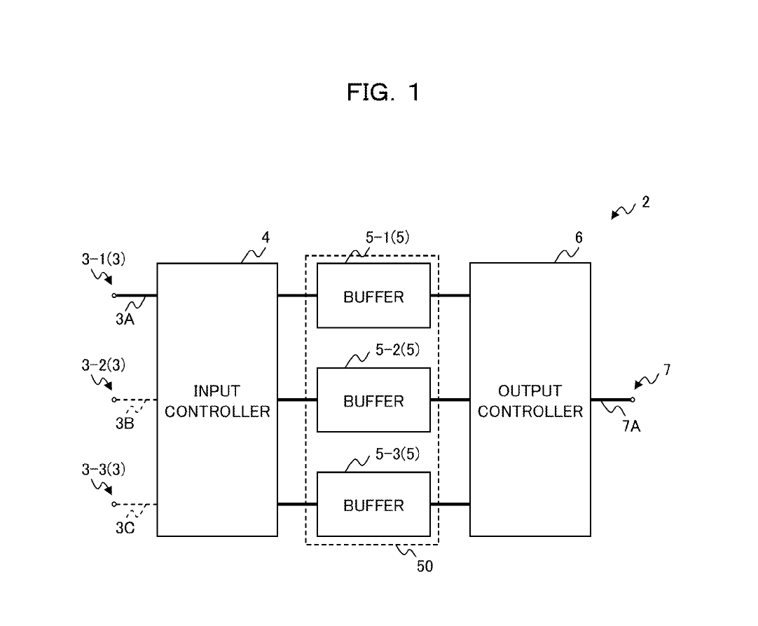

FIG. 1 is a diagram illustrating an example of the configuration of a buffer device 2 according to an embodiment.

As illustrated in FIG. 1, the buffer device 2 includes a plurality of input ports, for example, three input ports 3-1 to 3-3, an input controller 4, a plurality of buffers, for example, three buffers 5-1 to 5-3, an output controller 6, and an output port 7. Note that, hereinafter, when not distinguishing the input ports 3-1 to 3-3 from each other and the buffers 5-1 to 5-3 from each other, the input ports 3-1 to 3-3 are simply referred to as the input ports 3 and the buffers 5-1 to 5-3 are simply referred to as the buffers 5.

The buffer device 2 is, for example, a device that relays data such as packets, that is, information, transmitted between devices of the outside (not illustrated) such as SBs or information processing devices such as servers. Hereinafter, the devices of the outside are simply referred to as outside devices.

The input ports 3 are ports that receive data input from a transmission-side outside device to the buffer device 2 and are connected to the transmission-side outside device via transmission paths. The data input to the input ports 3-1 to 3-3 are input to the input controller 4 via input paths 3A to 3C, respectively.

One ends of the input paths 3A to 3C are paths that are connected to the input ports 3-1 to 3-3, respectively, and the other ends thereof are connected to the input controller 4.

The buffers 5 are provided in parallel for the input ports 3-1 to 3-3, respectively, and are storage devices on which data input from the input ports 3 are written via the input controller 4. The data written on the buffers 5 are read by the output controller 6 and are output from the output port 7 via an output path 7A. Note that, examples of the buffers 5 include volatile memories such as RAMs.

The output port 7 is at least one port that outputs the data read from the buffers 5 by the output controller 6 from the buffer device 2 to a reception-side external device and is connected to the reception-side external device via a transmission path.

The output path 7A is a path of which one end is connected to the output controller 6 and the other end is connected to the output port 7.

Here, the buffer device 2 according to this embodiment can perform an operation by switching between an operation in which multi-input and single-output is performed by the input controller 4 and the output controller 6 and an operation in which single-input and single-output is performed by logical joining of the plurality of buffers 5. Hereinafter, the operation in which the buffer device 2 performs the multi-input and single-output is referred to as a normal operation and the operation in which the buffer device 2 performs single-input and single-output is referred to as a joint operation.

Specifically, the joint operation is one of the operation forms performed by the buffer device 2 to ensure a buffer capacity relevant to data transmission. The joint operation refers to an operation of switching a correspondence relation between the input ports 3 and the buffers 5 in the normal operation to a predetermined correspondence relation by the input controller 4.

For example, when data input from one input port 3 among the input ports 3-1 and 3-3 rather than all of the plurality of input ports 3-1 to 3-3 is desired to be output to one output port 7, buffer resources provided in correspondence with the unused input ports 3-1 to 3-3 are unused regions.

In this embodiment, a buffer capacity enabling, for example, long distance transmission to be performed is ensured in the buffer device 2 in the joint operation utilizing the buffers 5 of the unused regions.

In the joint operation of the buffer device 2, the input controller 4 writes the data input from a specific input port 3 on predetermined joint buffers (buffer group) 50 in which some of the buffers 5 or all of the buffers 5 are logically joined.

The joint buffers 50 exemplified in FIG. 1 are formed by all of the buffers 5 among the buffers 5-1 to 5-3. In the joint buffers 50 exemplified in FIG. 1, the input port 3-1 can be assigned as the specific input port. That is, in the joint operation of the buffers 5, the data input from input port 3-1 which is the specific input port is written on the buffers 5-1 to 5-3 that form the joint buffers 50 by the input controller 4.

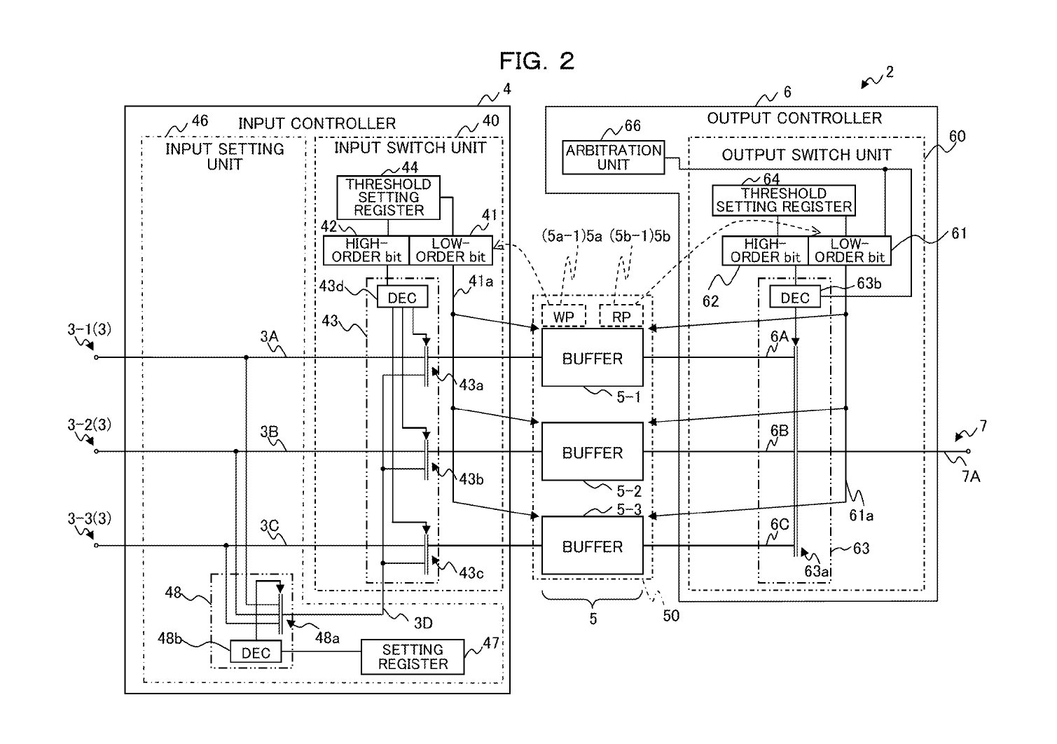

Specifically, the input controller 4 (an input switch unit 40 to be described below) selects a write target buffer 5 from the joint buffers 50 based on information indicating a write position in the buffers 5-1 to 5-3 forming the joint buffers 50, when the data is input from the input port 3-1 assigned to the joint buffers 50 in the joint operation. Then, the input controller 4 writes the data input from the input port 3-1 on the selected write target buffer 5. Note that, a method of selecting the write target buffer 5 based on the information indicating the write position by the input controller 4 will be described below with reference to FIG. 2 together with description of a detailed configuration of the input controller 4.

In the normal operation of the buffer device 2, the input controller 4 writes data input from the input ports 3-1 to 3-3 via the input paths 3A to 3C on the corresponding buffers 5. Specifically, in the normal operation, the input controller 4 writes the data input from the input port 3-1 via the input path 3A on the buffer 5-1. Likewise, in the normal operation, the input controller 4 writes the data input from the input port 3-2 via the input path 3B on the buffer 5-2 and writes the data input from the input port 3-3 via the input path 3C on the buffer 5-3.

In the joint operation, the output controller 6 selects a read target buffer 5 from the joint buffers 50 based on information indicating a read position in the buffers 5-1 to 5-3 that form the joint buffers 50. Then, the output controller 6 reads the data from the selected read target buffer 5 and outputs the data to the output port 7. Note that, a method of selecting the read target buffer 5 based on the information indicating the read position by the output controller 6 will be described below with reference to FIG. 2 together with description of a detailed configuration of the output controller 6.

In the normal operation, the output controller 6 selects a read target buffer 5 from the buffers 5-1 to 5-3, reads data written on the selected read target buffer 5, and outputs the data to the output port 7.

As described above, in the joint operation, the buffer device 2 exemplified in FIG. 1 functions as a reception buffer corresponding to single-input and single-output in which the data input to the input port 3-1 is output from the output port 7.

The input controller 4 and the output controller 6 function as buffer control devices that perform control to write data on the buffers 5 and read data from the buffers 5 according to the operation form of the buffer device 2.

[1-2] Detailed Configuration of Buffer Device

Next, the detailed configuration of the above-described buffer device 2 will be described with reference to FIG. 2.

FIG. 2 is a diagram illustrating an example of a detailed configuration of the buffer device 2 illustrated in FIG. 1.

Note that, the description will be made assuming that the joint buffers 50 in the buffer device 2 exemplified in FIG. 2 are formed by the buffers 5-1 to 5-3.

The buffer device 2 includes write control pointers 5a-1 to 5a-3 and read control pointers 5b-1 to 5b-3 corresponding to the buffers 5-1 to 5-3, respectively. Note that, to simplify the drawing, only the write control pointer 5a-1 and the read control pointer 5b-1 corresponding to the buffer 5-1 are illustrated in FIG. 2. Hereinafter, when not distinguishing the write control pointers 5a-1 to 5a-3 and the read control pointers 5b-1 to 5b-3 from each other, the write control pointers 5a-1 to 5a-3 are simply referred to as the write control pointers 5a and the read control pointers 5b-1 to 5b-3 are simply referred to as the read control pointers 5b. In FIG. 2, the write control pointer 5a and the read control pointer 5b are denoted by a WP and an RP, respectively.

In the normal operation, since a write address indicating a write position on the corresponding buffer 5 is recorded as a pointer value in the write control pointer 5a, input data to the buffer 5 is written on an address position indicated by the pointer value of the corresponding write control pointer 5a by the input controller 4. In the normal operation, the write control pointer 5a changes the own pointer value, for example, increments (increases) the own pointer value, whenever input data to the corresponding buffer 5 is written.

In the normal operation, since a read address indicating a read position of output data from the corresponding buffer 5 is recorded as a pointer value in the read control pointer 5b, the output data from the buffer 5 is read from the address position indicated by the pointer value of the corresponding read control pointer 5b by the output controller 6. In the normal operation, the read control pointer 5b changes the own pointer value, for example, increments (increases) the own pointer value, whenever the output data from the corresponding buffer 5 is read.

Note that, the pointer values of the write control pointer 5a and the read control pointer 5b exceed the upper limit or the like of addresses usable in the buffer 5 due to, for example, the increment in the pointer values, the pointer values are reset to the initial values by the write control pointer 5a and the read control pointer 5b.

[1-2-1] Detailed Configuration of Input Controller

The input controller 4 includes the input switch unit 40 and an input setting unit 46.

In either the normal operation or the joint operation, the input setting unit 46 outputs data input from the input ports 3-1 to 3-3 to the input switch unit 40 via the corresponding input paths 3A to 3C.

In the joint operation, the input setting unit 46 outputs the input data to the input switch unit 40 via a joint path 3D, when data is input from a specific input port 3 assigned to the joint buffers 50.

In the normal operation, the input switch unit 40 writes the data input from the input setting unit 46 via the input paths 3A to 3C on the corresponding buffers 5-1 to 5-3.

In the joint operation, the input switch unit 40 writes the data input from the input setting unit 46 via the joint path 3D on a write target buffer 5 of the joint buffers 50.

That is, in the normal operation, the input controller 4 writes the data input from the input ports 3-1 to 3-3 via the input paths 3A to 3C on the corresponding buffers 5 by the input switch unit 40 and the input setting unit 46. In the joint operation, on the other hand, the input controller 4 writes the data input from the specific input port 3 via the joint path 3D on the write target buffer 5 in the joint buffers 50.

Hereinafter, the detailed configurations of the input switch unit 40 and the input setting unit 46 will be described.

First, the input setting unit 46 will be described.

The input setting unit 46 includes a set register (second register) 47 and a selection unit 48.

In the set register 47, information indicating the specific input port 3 assigned to the joint buffers 50, that is, the specific input paths 3A to 3C, is set and retained in, for example, initial setting of the joint operation. The description will be made below assuming that the set register 47 retains the information indicating the input port 3-1 as the specific input port 3.

In the joint operation, the selection unit 48 selects the input port 3 assigned to the joint buffers 50 from the plurality of input ports 3-1 to 3-3 based on the information retained in the set register 47 and outputs the data input from the selected input port 3 to the input switch unit 40 via the joint path 3D.

The selection unit 48 includes a selector 48a and a decoder 48b.

In the selector 48a, a plurality of paths divided from the input paths 3A to 3C are connected to its input side and the joint path 3D is connected to its output side.

The decoder 48b outputs a control signal (selection signal) to the selector 48a so that the path corresponding to the specific input port 3 assigned to the joint buffers 50 is selected based on the information retained in the set register 47. Note that, the decoder 48b is denoted by DEC in FIG. 2.

That is, in the joint operation, the selector 48a selects the path selected by the control signal from the decoder 48b, that is, the path corresponding to the input port 3-1, from the plurality of paths connected to the input side. Then, the selector 48a outputs the data input from the input port 3-1 via the selected path to the joint path 3D.

Note that, as described above, the specific input port 3 assigned to the joint buffers 50 is determined based on the information such as a register value set in the set register 47. The setting of the set register 47 is determined by a connection topology of an XB, to which the buffer device 2 according to this embodiment is applied, and an LSI of a peripheral SB, another XB, or the like.

When the connection topology is changed due to a change or the like in the system configuration, for example, a firmware that monitors the system configuration to which the buffer device 2 is applied or an administrator or the like of the system can set the information such as a register value suitable for the set register 47 again. Hereinafter, the firmware and the administrator or the like of the system are collectively referred to as a firmware.

That is, the firmware can set the specific input port 3 in the set register 47, when the buffer device 2 is used as, for example, a reception buffer of single-input and single-output due to a change in the system configuration. Further, the firmware can be configured to reset the specific input port 3 set in the set register 47 so that the normal operation is performed in the buffer device 2, when the buffer device 2 is used as a multi-input and single-output due to a change in the system configuration.

The change in the set value of the set register 47 by the firmware can be performed likewise even while a system to which the buffer device 2 is applied is operating. For example, by providing a function of temporarily blocking data arriving at the buffer device 2 performing the setting change of the set register 47 in, for example, the buffer device 2 or an XB to which the buffer device 2 is applied, the setting change of the set register 47 can be dynamically performed without shutdown of the system.

Next, the input switch unit 40 will be described.

In the joint operation, the input switch unit 40 switches the write target buffer 5 to another buffer 5 among the joint buffers 50 based on information indicating the write position in the buffer 5 of the joint buffers 50.

The input switch unit 40 includes a low-order bit pointer (first pointer) 41, a high-order bit pointer (second pointer) 42, a first switch unit 43, and a threshold value set register 44.

The low-order bit pointer 41 retains a first pointer value indicating a write position in a write target buffer 5 among the joint buffers 50, that is, in one buffer 5 among the buffers 5 that form the joint buffers 50. That is, the low-order bit pointer 41 is a write control pointer that is used in common by the buffers 5-1 to 5-3 that form the joint buffers 50 in the joint operation. Note that, the low-order bit pointer 41 is denoted by a low-order bit in FIG. 2.

The input switch unit 40 may include, as the low-order bit pointer 41, the same write control pointer 41 as the write control pointer 5a provided in correspondence with the buffer 5 or may divert the write control pointer 5a provided in correspondence with one buffer 5 among the buffers 5-1 to 5-3 that form the joint buffers 50.

In this embodiment, the description will be made below assuming that the low-order bit pointer 41 is diverted from the write control pointer 5a-1 included in the buffer 5-1. Note that, in FIG. 2, a dashed arrow oriented from the write control pointer 5a-1 to the low-order bit pointer 41 indicates that the write control pointer 5a-1 is diverted as the low-order bit pointer 41.

In the joint operation, the low-order bit pointer 41 designates a write position, that is, an address position when the data input from the specific input port 3 is written on the write target buffer 5.

In the joint operation, the low-order bit pointer 41 changes the first pointer value, for example, increments (increases) the first pointer value, when the data input from the specific input port 3 is written on the write target buffer 5.

When the first pointer value of the low-order bit pointer 41 exceeds the upper limit or the like of an address usable in the buffer 5, as in the pointer value of the write control pointer 5a, the first pointer value is reset to the initial value such as the lower limit or the like of an address usable in the buffer 5 by the low-order bit pointer 41.

Hereinafter, a threshold value, such as the upper limit of the address usable in the buffer 5, indicating the full state of a storage region such as a RAM included in the buffer 5 is referred to as a first threshold value.

The low-order bit pointer 41, for example, the write control pointer 5a-1 illustrated in FIG. 2, and each of the buffers 5 that form the joint buffers 50 are connected to each other via a line 41a. The low-order bit pointer 41 can designate an address position at which data is written on the write target buffer 5 via the line 41a or detect that data is written as a trigger of an increment in the first pointer value.

Note that, of the write control pointers 5a, the write control pointers 5a which are provided in the buffers 5 that form the joint buffers 50 and are not used as the low-order bit pointer 41 are set to be invalid in the initial setting or the like of the joint operation and are maintained to be in the invalid state during the joint operation. That is, when the write control pointer 5a-1 is used as the low-order bit pointer 41, the write control pointers 5a-2 and 5a-3 (not illustrated) are maintained to be in the invalid state in the joint operation and do not perform the process when the data is written on the corresponding buffers 5-2 and 5-3.

The high-order bit pointer 42 is a pointer that maintains a value which is changed according to the first pointer value of the low-order bit pointer 41, for example, a second pointer value which is incremented according to the first pointer value. Note that, the high-order bit pointer 42 is denoted by a high-order bit in FIG. 2.

Specifically, in the joint operation, for example, the high-order bit pointer 42 increments (increases) the second pointer value, when the first pointer value reaches the first threshold value. In other words, the second pointer value retained by the high-order bit pointer 42 can be said to be a pointer value indicating a high-order bit higher than the first pointer value retained by the low-order bit pointer 41.

The second pointer value is used to select the write target buffer 5 from the buffers 5-1 to 5-3 that form the joint buffers 50 by the first switch unit 43 to be described below.

In this embodiment, for example, the first switch unit 43 selects the buffer 5-1 as the write target buffer 5 when the second pointer value is “00,” selects the buffer 5-2 as the write target buffer 5 when the second pointer value is “01,” and selects the buffer 5-3 as the write target buffer 5 when the second pointer value is “10.” That is, the input switch unit 40 causes the continuous second pointer values to correspond to the buffers 5-1 to 5-3 that form the joint buffers 50 and selects the corresponding buffer 5 as the write target buffer 5 according to the second pointer value.

That is, by setting the second pointer values assigned to the buffers 5, the order of the buffers 5 selected as the write target buffer 5 can be determined arbitrarily.

When the second pointer value exceeds a second threshold value, for example, the second pointer value is reset to the initial value such as “00” which is the minimum value by the high-order bit pointer 42.

Here, the second threshold value is, for example, the maximum value among the second pointer values indicating the buffers 5-1 to 5-3 that form the joint buffers 50. In this embodiment, the second threshold value is the second pointer value when the buffer 5-3 is selected, that is, “10.” Accordingly, in the high-order bit pointer 42, the write target buffer 5 is selected periodically in a predetermined order from the buffers 5-1 to 5-3 that form the joint buffers 50 according to the second pointer value.

In the normal operation, the high-order bit pointer 42 is configured to suppress output of the second pointer value to the first switch unit 43. In the normal operation, the high-order bit pointer 42 may output, to the first switch unit 43, a predetermined pointer value indicating the normal operation, for example, a larger pointer value, such as “11,” than the second threshold value which does not correspond to the buffers 5-1 to 5-3 that form the joint buffers 50.

In the threshold value set register 44, the first and second threshold values are set and retained in the initial setting or the like of the joint operation. In the joint operation, the low-order bit pointer 41 and the high-order bit pointer 42 each perform, for example, the increment or the resetting of the first pointer value and the second pointer value described above based on the first threshold value and the second threshold value retained in the threshold value set register 44.

In the joint operation, the first switch unit 43 switches the write target buffer 5 in the joint buffers 50 to another buffer 5 among the joint buffers 50 according to the change in the second pointer value of the high-order bit pointer 42. The first switch unit 43 writes the data input from the input port 3-1 on the write position indicated by the first pointer value in the write target buffer 5.

The first switch unit 43 includes a decoder 43d and selectors 43a to 43c corresponding to the input ports 3-1 to 3-3 and the buffers 5-1 to 5-3, respectively. Note that, the decoder 43d is denoted by DEC in FIG. 2.

In the selectors 43a to 43c, the corresponding input paths 3A to 3C are connected to input sides thereof and the joint path 3D is connected to the input sides and the corresponding buffers 5-1 to 5-3 are connected to output sides thereof.

That is, in the selector 43a, the input path 3A corresponding to the input port 3-1 and the joint path 3D are connected to its input side and the buffer 5-1 is connected to its output side. Likewise, in the selector 43b, the input path 3B corresponding to the input port 3-2 and the joint path 3D are connected to its input side and the buffer 5-2 is connected to its output side. Further, in the selector 43c, the input path 3C corresponding to the input port 3-3 and the joint path 3D are connected to its input side and the buffer 5-3 is connected to its output side.

In the joint operation, the decoder 43d selects the write target buffer 5 based on the second pointer value of the high-order bit pointer 42 and outputs a control signal (selection signal) to each of the selectors 43a to 43c so that the data input from the specific input port 3 is written on the write target buffer 5.

Specifically, in the joint operation, the decoder 43d selects the buffer 5 corresponding to the second pointer value as the write target buffer 5. Then, the decoder 43d outputs a control signal to the selectors 43a to 43c corresponding to the write target buffer 5 so that the joint path 3D is selected. On the other hand, the decoder 43d outputs a control signal to the selectors 43a to 43c corresponding to the buffers 5 that form the joint buffers 50 other than the write target buffer 5 so that none of the corresponding input paths 3A to 3C and the joint path 3D is selected.

In this embodiment, for example, the decoder 43d selects the buffer 5-1 as the write target buffer 5 when the second pointer value is “00,” and outputs a control signal indicating that the joint path 3D is selected to the selector 43a corresponding to the buffer 5-1. On the other hand, the decoder 43d outputs a control signal to the selectors 43b and 43c so that none of the corresponding input paths 3B and 3C and the joint path 3D is selected.

The selector 43a selects the joint path 3D selected by the control signal from the decoder 43d from the paths connected to the input side and writes the data input from the specific input port 3 via the selected joint path 3D, that is, the data input from the input port 3-1, on the corresponding write target buffer 5-1.

On the other hand, based on a control signal from the decoder 43d, the selectors 43b and 43c select none of the corresponding input paths 3B and 3C and the joint path 3D and do not write the data on the corresponding buffers 5-2 and 5-3.

Even when the second pointer value is “01” or “10” and the buffer 5-2 or 5-3 is selected as the write target buffer 5 by the decoder 43d, the processes of the decoder 43d and the selectors 43a to 43c are the same as those of the case in which the second pointer value is “00.”

That is, in this embodiment, in the joint operation, the decoder 43d controls the control signal such that the selector 43a is selected when the second pointer value is “00,” the selector 43b is selected when the second pointer value is “01,” and the selector 43c is selected when the second pointer value is “10.” That is, under the control of the control signal by the decoder 43d, the selectors 43a to 43c writing the data input from the input port 3-1 via the joint path 3D on the write target buffer 5 are selected.

Note that, the input switch unit 40 may include a register or the like that retains information indicating a correspondence relation between the above-described second pointer values and the buffers 5-1 to 5-3 selected as the write target buffer 5, that is, the selectors 43a to 43c. In this register, for example, the correspondence relation between the second pointer values and the buffers 5, that is, the selectors 43a to 43c is set in the initial setting or the like of the joint operation.

In the normal operation, the decoder 43d outputs a control signal to each of the selectors 43a to 43c so that the data input from the input ports 3-1 to 3-3 via the input paths 3A to 3C is written on the corresponding buffers 5.

That is, in the normal operation, the selectors 43a to 43c each select the corresponding input paths 3A to 3C selected by the control signal from the decoder 43d from the paths connected to the input side. Then, the selectors 43a to 43c each write the data input from the corresponding input ports 3-1 to 3-3 via the selected input paths 3A to 3C on the corresponding buffers 5-1 to 5-3.

Note that, the input switch unit 40 can have a valid/invalid flag for path selection based on the second pointer value by the decoder 43d to administrate switching between validation/invalidation of the selection of the selectors 43a to 43c based on the second pointer value.

That is, the decoder 43d can perform the switching between the joint operation and the normal operation based on the value of the valid/invalid flag.

For example, the valid/invalid flag is set such that the valid/invalid flag is valid in the initial setting or the like of the joint operation and is set such that the valid/invalid flag is invalid in the initial setting or the like of the normal operation.

Note that, in a case in which the valid/invalid flag is not be provided, the decoder 43d may determine the normal operation when the second pointer value is not input from the high-order bit pointer 42 or the second pointer value is a predetermined pointer value such as “11” indicating the normal operation.

[1-2-2] Detailed Configuration of Output Controller

The output controller 6 includes an output switch unit 60 and an arbitration unit 66.

The arbitration unit 66 adjusts a read timing of the data from the buffer 5 in either the normal operation or the joint operation. Note that, the arbitration unit 66 selects a read target buffer 5 using, for example, an LRU scheme or a round-robin scheme.

Specifically, in the joint operation, the arbitration unit 66 outputs an instruction to read the data written on the buffer 5 to the output switch unit 60 at each read timing of the data from the buffer 5.

Note that, the arbitration unit 66 is connected to, for example, a reception-side outside device (not illustrated) connected from the output port 7 via a transmission path, and timing information is input from the reception-side outside device. Based on the input timing information, the arbitration unit 66 adjusts the read timing of the data from the buffer 5. The timing information includes, for example, an instruction to output data from the output port 7 at constant time intervals or an instruction indicating interruption or restart of the output of the data from the output port 7, for example, when the reception-side outside device is in a busy state.

In the normal operation, the arbitration unit 66 selects (adjusts) the read target buffer 5.

Specifically, in the normal operation, the arbitration unit 66 outputs (issues) an instruction to read the data written on the selected read target buffer 5 to the output switch unit 60 at each read timing of the data from the buffer 5.

Note that, although not illustrated in FIG. 2, a line used to increment a pointer value indicating a read position in the normal operation can be provided for each of the read control pointers 5b-1 to 5b-3 from the arbitration unit 66. That is, in the normal operation, the arbitration unit 66 causes the corresponding read control pointer 5b to increment the pointer value when the data is read from the read target buffer 5.

In the joint operation, the output switch unit 60 selects the read target buffer 5 from the buffers 5 that form the joint buffers 50 based on a data read instruction input from the arbitration unit 66, reads the data from the selected buffer 5, and outputs the data to the output port 7 via the output path 7A.

In the normal operation, the output switch unit 60 reads data from the read target buffer 5 based on a data read instruction input from the arbitration unit 66 and outputs the data to the output port 7 via the output path 7A.

Hereinafter, the output switch unit 60 will be described.

The output switch unit 60 includes a low-order bit pointer (third pointer) 61, a high-order bit pointer (fourth pointer) 62, a second switch unit 63, and a threshold value set register 64.

The low-order bit pointer 61 retains a third pointer value indicating a read position in the read target buffer 5 among the joint buffers 50. That is, in the joint operation, the low-order bit pointer 61 is a read control pointer which is used in common by the buffers 5-1 to 5-3 that form the joint buffers 50. Note that, the low-order bit pointer 61 is denoted by a low-order bit in FIG. 2.

The output switch unit 60 may include, as the low-order bit pointer 61, the same read control pointer 61 as the read control pointer 5b provided in correspondence with the buffer 5 or may divert the read control pointer 5b provided in correspondence with one buffer 5 among the buffers 5-1 to 5-3 that form the joint buffers 50.

In this embodiment, the description will be made below assuming that the low-order bit pointer 61 is diverted from the read control pointer 5b-1 included in the buffer 5-1. Note that, in FIG. 2, a dashed arrow oriented from the read control pointer 5b-1 to the low-order bit pointer 61 indicates that the read control pointer 5b-1 is diverted as the low-order bit pointer 61.

In the joint operation, the low-order bit pointer 61 designates a read position, that is, an address position, when a read instruction is input from the arbitration unit 66 and the data is read from the buffers 5-1 to 5-3 that form the joint buffers 50. In the joint operation, the low-order bit pointer 61 changes the third pointer value, for example, increments (increases) the third pointer value, when the read instruction is input from the arbitration unit 66 or the data is read from the read target buffer 5 by the second switch unit 63.

When the third pointer value exceeds a first threshold value, as in the first pointer value of the low-order bit pointer 41 of the input switch unit 40, the third pointer value of the low-order bit pointer 61 is reset to the initial value such as the lower limit of an address usable in the buffer 5 by the low-order bit pointer 61.

The low-order bit pointer 61, for example, the read control pointer 5b-1 illustrated in FIG. 2, and each of the buffers 5 that form the joint buffers 50 are connected to each other via a line 61a. The low-order bit pointer 61 can designate an address position at which the data is read from the read target buffer 5 via the line 61a or detect that data is read as a trigger of an increment in the third pointer value.

Note that, of the read control pointers 5b, the read control pointers which are provided in the buffers 5 that form the joint buffers 50 and are not used as the low-order bit pointer 61 are set to be invalid in the initial setting or the like of the joint operation and are maintained to be in the invalid state during the joint operation. That is, when the read control pointer 5b-1 is used as the low-order bit pointer 61, the read control pointers 5b-2 and 5b-3 (not illustrated) are maintained to be in the invalid state in the joint operation and do not perform the process when the data is read from the corresponding buffers 5-2 and 5-3.

The high-order bit pointer 62 is a pointer that maintains a value which is changed according to the third pointer value of the low-order bit pointer 61, for example, a fourth pointer value which is incremented according to the third pointer value. Note that, the high-order bit pointer 62 is denoted by a high-order bit in FIG. 2.

Specifically, in the joint operation, for example, the high-order bit pointer 62 increments (increases) the fourth pointer value, when the third pointer value reaches the first threshold value. In other words, the fourth pointer value retained by the high-order bit pointer 62 can be said to be a pointer value indicating a high-order bit higher than the third pointer value retained by the low-order bit pointer 61.

The fourth pointer value is used to select the read target buffer 5 from the buffers 5-1 to 5-3 that form the joint buffers 50 by the second switch unit 63 to be described below.

In this embodiment, for example, the second switch unit 63 selects the buffer 5-1 as the read target buffer 5 when the fourth pointer value is “00,” selects the buffer 5-2 as the read target buffer 5 when the fourth pointer value is “01,” and selects the buffer 5-3 as the read target buffer 5 when the fourth pointer value is “10.” That is, the output switch unit 60 causes the continuous fourth pointer values to correspond to the buffers 5-1 to 5-3 that form the joint buffers 50 and selects the corresponding buffer 5 as the read target buffer 5 according to the fourth pointer value.

That is, by setting the fourth pointer values assigned to the buffers 5, the order of the buffers 5 selected as the read target buffer 5 can be determined arbitrarily.

When the fourth pointer value exceeds a second threshold value, as in the high-order bit pointer 42 of the input switch unit 40, for example, the fourth pointer value is reset to the initial value such as “00” which is the minimum value by the high-order bit pointer 62.

Accordingly, in the high-order bit pointer 62, the read target buffer 5 is selected periodically in a predetermined order from the buffers 5-1 to 5-3 that form the joint buffers 50 according to the fourth pointer value.

In the normal operation, the high-order bit pointer 62 may be configured to suppress output of the fourth pointer value to the second switch unit 63.

In the threshold value set register 64, the first and second threshold values are set and retained in the initial setting or the like of the joint operation. In the joint operation, the low-order bit pointer 61 and the high-order bit pointer 62 each perform the process such as the increment or the resetting of the third pointer value and the fourth pointer value described above based on the first threshold value and the second threshold value retained in the threshold value set register 64.

Note that, when the low-order bit pointers 41 and 61 and the high-order bit pointers 42 and 62 can acquire the first and second threshold values from one of the threshold value set registers 44 and 64, the other threshold value set register 44 or 64 may be omitted.

In the joint operation, the second switch unit 63 switches the read target buffer 5 in the joint buffers 50 to another buffer 5 among the joint buffers 50 according to the change in the fourth pointer value of the high-order bit pointer 62. The second switch unit 63 reads the data from the read position indicated by the third pointer value in the read target buffer 5 and outputs the data to the output port 7.

The second switch unit 63 includes a selector 63a and a decoder 63b. Note that, the decoder 63b is denoted by DEC in FIG. 2

In the selector 63a, read paths 6A to 6C respectively corresponding to the buffers 5-1 to 5-3 are connected to its input side and the output path 7A is connected to its output side.

In the joint operation, the decoder 63b selects the read target buffer 5 based on the fourth pointer value of the high-order bit pointer 62 and outputs a control signal (selection signal) to the selector 63a so that the data is read from the read target buffer 5.

Specifically, in the joint operation, the decoder 63b selects the buffer 5 corresponding to the fourth pointer value as the read target buffer 5. Then, the decoder 63b outputs a control signal to the selector 63a so that the read paths 6A to 6C connected to the read target buffer 5 are selected.

In this embodiment, for example, the decoder 63b selects the buffer 5-1 as the read target buffer 5 when the fourth pointer value is “00,” and outputs a control signal indicating that the read path 6A is selected to the selector 63a.

The selector 63a selects the read path 6A selected by the control signal from the decoder 63b from the paths connected to the input side, reads the data from the read target buffer 5 via the selected read path 6A, and outputs the data to the output path 7A connected to the output side.

Even when the fourth pointer value is “01” or “10” and the buffer 5-2 or 5-3 is selected as the read target buffer 5 by the decoder 63b, the processes of the decoder 63b and the selector 63a are the same as those of the case in which the fourth pointer value is “00.”

That is, in this embodiment, in the joint operation, the decoder 63b controls the control signal output to the selector 63a such that the read path 6A is selected when the fourth pointer value is “00,” the read path 6B is selected when the fourth pointer value is “01,” and the read path 6C is selected when the fourth pointer value is “10.” That is, under the control of the control signal by the decoder 63b, the read paths 6A to 6C reading the data from the read target buffer 5 are selected.

Note that, the output switch unit 60 may include a register or the like that retains information indicating a correspondence relation between the above-described fourth pointer values and the buffers 5-1 to 5-3 selected as the read target buffer 5, that is, the read path 6A to 6C. In this register, for example, the correspondence relation between the fourth pointer values and the buffers 5, that is, the read paths 6A to 6C is set in the initial setting or the like of the joint operation.

The decoder 63b is connected to the arbitration unit 66. In the normal operation, when a read instruction designating the read target buffer 5 is input from the arbitration unit 66, the decoder 63b outputs a control signal (selection signal) to the selector 63a so that the data is read from the read target buffer 5.

That is, in the normal operation, the selector 63a selects the read paths 6A to 6C selected by the decoder 63b from the paths connected to the input side according to the control signal from the decoder 63b based on the read instruction from the arbitration unit 66. Then, the selector 63a reads the data from the read target buffer 5 via the selected read paths 6A to 6C and outputs the data to the output path 7A connected to the output side.

Note that, as in the input switch unit 40, the output switch unit 60 can include a valid/invalid flag for path selection based on the fourth pointer value by the decoder 63b to administrate switching between validation/invalidation of the selection of the selector 63a based on the fourth pointer value.

That is, the decoder 63b can perform the switching between the joint operation and the normal operation based on the value of the valid/invalid flag.

For example, the valid/invalid flag is set such that the valid/invalid flag is valid in the initial setting or the like of the joint operation and is set such that the valid/invalid flag is invalid in the initials setting or the like of the normal operation.

Note that, in a case in which the valid/invalid flag is not provided, the decoder 63b may determine the normal operation when the fourth pointer value is not input from the high-order bit pointer 62 or the read instruction designating the read target buffer 5 is input from the arbitration unit 66.

Note that, in the normal operation, the arbitration unit 66 may output a control signal to the selector 63a so that the read paths 6A to 6C corresponding to the read target buffer 5 are selected, instead of outputting information designating the read target buffer 5 to the decoder 63b.

[1-3] Process of Buffer Device

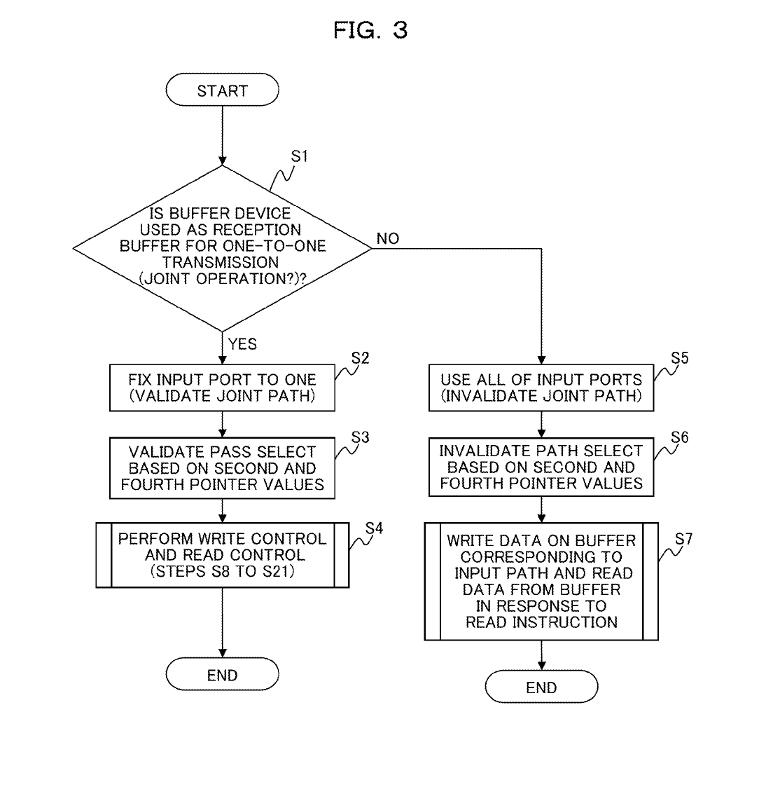

Next, an example of a process in the buffer device 2 having the above-described configuration as an example of the embodiment will be described with reference to FIGS. 3 to 6.

FIG. 3 is a flowchart illustrating an initial setting order of a normal operation and a joint operation performed by the buffer device 2 according to the embodiment.

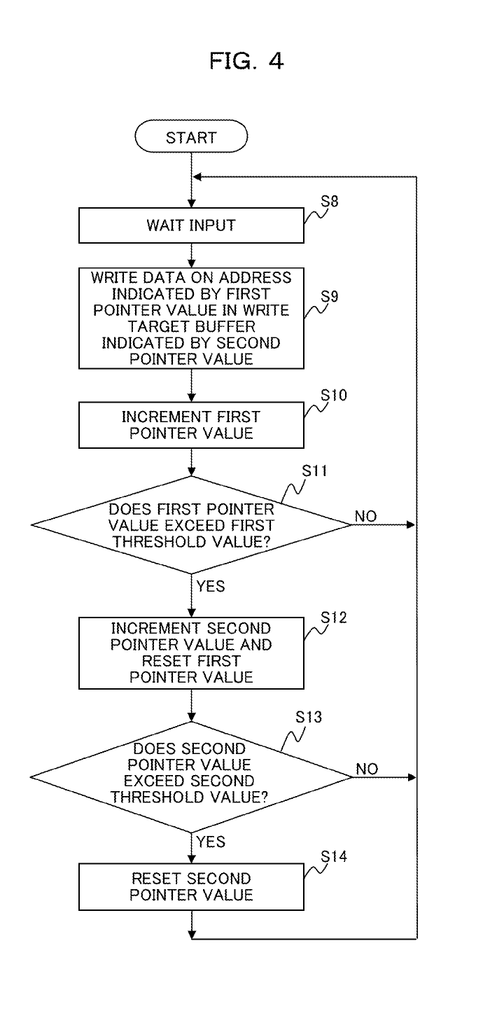

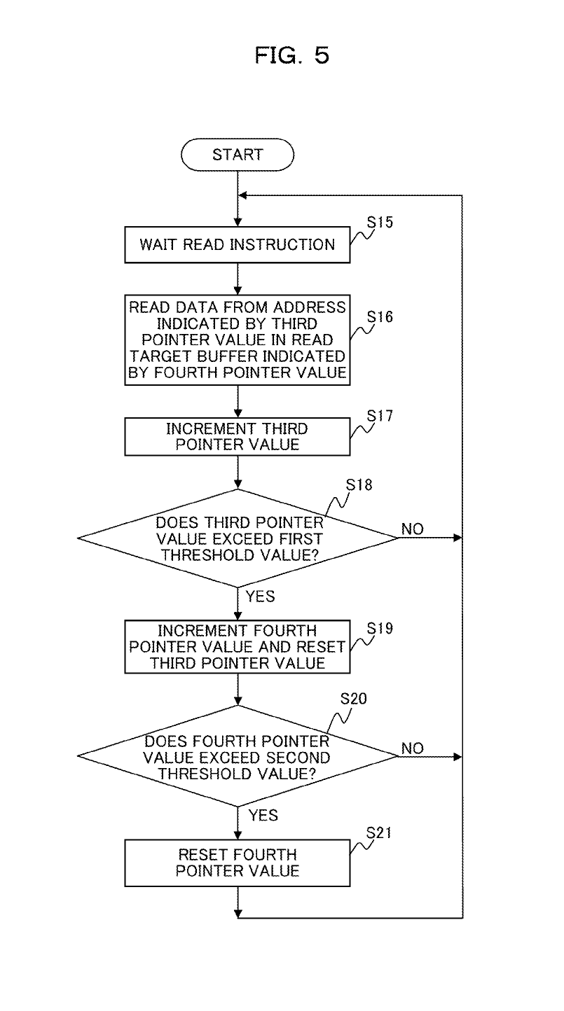

FIG. 4 is a flowchart illustrating an example of a process in the joint operation performed by the input controller 4 of the buffer device 2 according to the embodiment. FIG. 5 is a flowchart illustrating an example of a process in the joint operation performed by the output controller 6 of the buffer device 2 according to the embodiment.

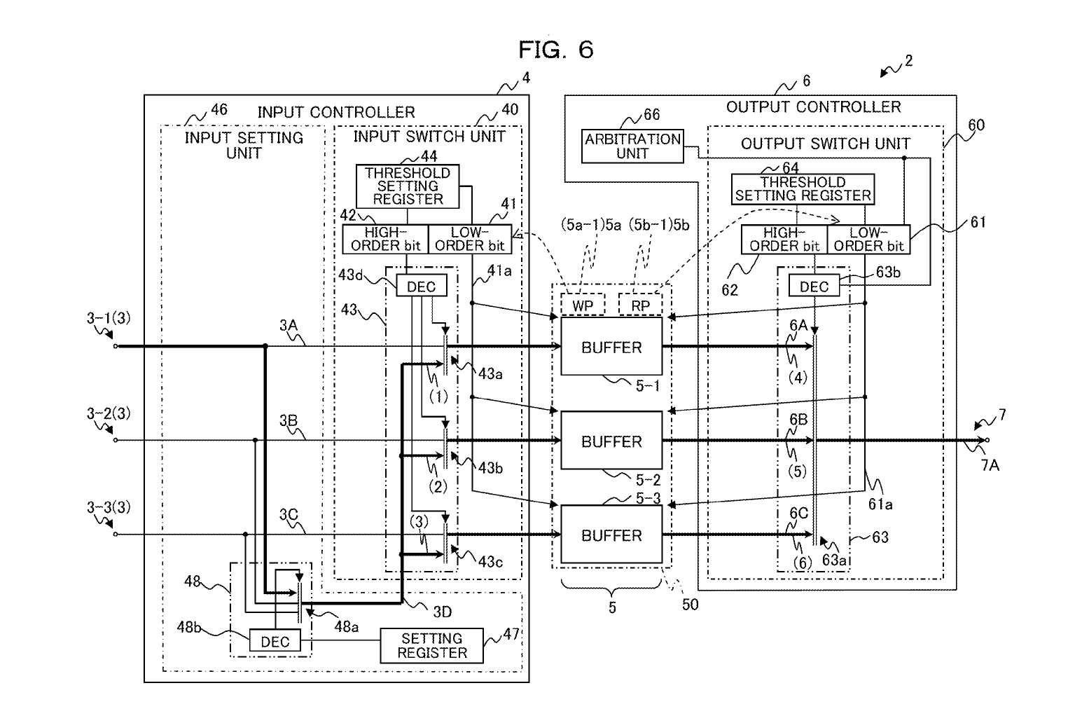

FIG. 6 is a diagram illustrating an example of a process in the joint operation of the buffer device 2 illustrated in FIG. 2.

First, the initial setting order in the buffer device 2 as an example of the embodiment will be described with reference to FIG. 3.

First, the firmware determines whether the buffer device 2 is used as a reception buffer for data transmission that performs single-input and single-output, that is, performs the joint operation (step S1). This determination is performed for each buffer device 2 functioning as an output buffer mechanism installed in an XB or the like in the system according to the connection topology.

Note that, the determination in step S1 by the firmware may be performed during stop of the system or may be performed by temporarily blocking the data input to the buffer device 2 during the operation of the system.

When the firmware determines in step S1 that the buffer device 2 is used as the reception buffer for data transmission that performs the single-input and single-output (Yes route of step S1), the firmware specifies the input port 3 to which data is to be input when the buffer device 2 performs the single-input and single-output, as the initial setting of the joint operation. Then, information indicating the specific input port 3 is set in the set register 47 by the firmware and the specific input port 3 is used fixedly in the joint operation (step S2). That is, the joint path 3D outputting the data input from the specific input port 3 to the input switch unit 40 is validated by the firmware.

Subsequently, the firmware sets the valid/invalid flags of the input controller 4 and the output controller 6 such that the valid/invalid flags are valid (step S3). That is, the path selection based on the second and fourth pointer values by the decoders 43d and 63b, that is, the selection of the selectors 43a to 43c based on the second pointer value and the selection of the read paths 6A to 6C based on the fourth pointer value, is validated.

Note that, when the write control pointer 5a and the read control pointer 5b are diverted as the lower-order bit pointers 41 and 61, the firmware validates the setting such that the diverted write control pointer 5a and the diverted read control pointer 5b are used as the lower-order bit pointers 41 and 61. Further, the firmware invalidates the write control pointers 5a and the read control pointers 5b which are not diverted.

When the process of step S3 is performed, the joint operation is performed in the buffer device 2, and write control of the data input from the specific input port 3 on the joint buffers 50 and read control of the data from the joint buffers 50 are performed (step S4). Note that, a processing example of the write control in step S4 will be described below with reference to step S8 to step S14 of FIG. 4 and FIG. 6. A processing example of the read control will be described below with reference to step S15 to step S21 of FIG. 5 and FIG. 6.

Conversely, when the firmware determines in step S1 that the buffer device 2 is not used as the reception buffer for data transmission that performs the single-input and single-output (No route of step S1), the firmware resets the value set in the set register 47 as the initial setting of the normal operation (step S5). That is, the firmware invalidates the joint path 3D so that all of the input ports 3 can be used.

Subsequently, the firmware sets the valid/invalid flags of the input controller 4 and the output controller 6 such that the valid/invalid flags are invalid (step S6). That is, the path selection based on the second and fourth pointer values by the decoders 43d and 63b, that is, the selection of the selectors 43a to 43c based on the second pointer value and the selection of the read paths 6A to 6C based on the fourth pointer value, is invalidated.

When the process of step S6 is performed, the data input from the input ports 3 via the input paths 3A to 3C is written on the corresponding buffers 5 as the normal operation in the buffer device 2 under the control of the decoder 43d on the selectors 43a to 43c. The data is read from the read target buffer 5 according to the read instruction as the normal operation in buffer device 2 under the control of the arbitration unit 66 and the decoder 63b on the read paths 6A to 6C (step S7).

Next, a processing example in the joint operation by the input controller 4 of the buffer device 2 according to this embodiment will be described with reference to FIGS. 4 and 6.

Hereinafter, a case will be described in which the buffer device 2 illustrated in FIG. 6 completes the processes of step S1 to step S3 of FIG. 3 and performs the joint operation of step S4 using the input port 3-1 as the specific input port 3.

As illustrated in FIG. 4, first, the input controller 4 awaits input of data from the input port 3 (step S8). When the data is input to the input port 3-1, the input controller 4 writes the data on an address position indicated by the first pointer value of the low-order bit pointer 41 in the write target buffer 5 indicated by the second pointer value of the high-order bit pointer 42 (step S9).

In the example illustrated in FIG. 6, the data input from the input port 3-1 is input to the selector 48a of the selection unit 48 and is input to the first switch unit 43 via the joint path 3D.

In the initial state of the buffer device 2, all of the bits of both of the first and second pointer values are “0.” Accordingly, the write target buffer 5 is the buffer 5-1 corresponding to the second pointer value “00,” and the input data from the joint path 3D is written on the buffer 5-1 by the selector 43a selected by the decoder 43d (see (1) of FIG. 6).

The first pointer value is incremented when the data is written on one buffer 5 of the buffers 5-1 to 5-3 that form the joint buffers 50 (step S10). Whenever the data is written on the buffer 5, the low-order bit pointer 41 determines whether the first pointer value exceeds the first threshold value (step S11). When the low-order bit pointer 41 determines that the first pointer value does not exceed the first threshold value (No route of step S11), input of subsequent data is awaited and the process proceeds to step S8.

Conversely, when the low-order bit pointer 41 determines that the first pointer value exceeds the first threshold value (Yes route of step S11), the buffer 5-1 enters the full state and the low-order bit pointer 41 resets all of the bits of the first pointer value to “0.” The second pointer value of the high-order bit pointer 42 is incremented (step S12).

Whenever the second pointer value is incremented, it is determined whether the second pointer value exceeds the second threshold value (step S13). When it is determined that the second pointer value does not exceed the second threshold value (No route of step S13), input of subsequent data is awaited and the process proceeds to step S8.

By incrementing the second pointer value, the write target buffer 5-1 is switched to the buffer 5-2 corresponding to the second pointer value “01.” Accordingly, the input data from the joint path 3D is written on the buffer 5-2 by the selector 43b selected by the decoder 43d (see (2) of FIG. 6).

When the first pointer value exceeds the first threshold value and the buffer 5-2 enters the full state, all of the bits of the first pointer value are reset to “0” and the second pointer value is incremented. By incrementing the second pointer value, the write target buffer 5-2 is switched to the buffer 5-3 corresponding to the second pointer value “10.” Accordingly, the input data from the joint path 3D is written on the buffer 5-3 by the selector 43c selected by the decoder 43d (see (3) of FIG. 6).

When the first pointer value exceeds the first threshold value and the buffer 5-3 enters the full state, all of the bits of the first pointer value are reset to “0” and the second pointer value is incremented to become “11.” At this time, when the second pointer value exceeds the second threshold value (Yes route of step S13), the second pointer value is reset to “00” by the high-order bit pointer 42 (step S14) and the write target buffer 5-3 is switched to the buffer 5-1. Accordingly, the input data from the joint path 3D is written on the buffer 5-1 by the selector 43a selected by the decoder 43d (see (1) of FIG. 6).

In the joint operation, as described above, the input controller 4 ushers the data from the specific input port 3 set in the set register 47 to the joint path 3D without simultaneous use of the input paths 3A to 3C. The write target buffers 5 are switched according to the change in the first and second pointer values by the first switch unit 43, and the data input to the first switch unit 43 via the joint path 3D is written on the joint buffers 50.

Next, a processing example of the joint operation performed by the output controller 6 of the buffer device 2 according to this embodiment will be described with reference to FIGS. 5 and 6.

As illustrated in FIG. 5, first, the output switch unit 60 is in a waiting state of a read instruction from the arbitration unit 66 (step S15). When the read instruction is input to the output switch unit 60, the output controller 6 reads the data from the address position indicated by the third pointer value of the low-order bit pointer 61 in the read target buffer 5 indicated by the fourth pointer value of the high-order bit pointer 62 (step S16).

In the example illustrated in FIG. 6, all of the bits of the third and fourth pointer values of the low-order bit pointer 61 and the high-order bit pointer 62 are “0” in the initial state of the buffer device 2. Accordingly, the read target buffer 5 is the buffer 5-1 corresponding to the fourth pointer value “00,” the selector 63a to which the control signal is input by the decoder 63b reads the data written on the buffer 5-1 via the read path 6A (see (4) of FIG. 6).

The low-order bit pointer 61 increments the third pointer value when the read instruction is input from the arbitration unit 66 (step S17). Whenever the third pointer value is incremented, the low-order bit pointer 62 determines whether the third pointer value exceeds the first threshold value (step S18). When the low-order bit pointer 62 determines that the third pointer value does not exceed the first threshold value (No route of step S18), a subsequent read instruction is awaited and the process proceeds to step S15.

Conversely, when the low-order bit pointer 62 determines that the third pointer value exceeds the first threshold value (Yes route of step S18), the buffer 5-1 enters a state in which the data is read up to the final data storage region and the low-order bit pointer 61 resets all of the bits of the third pointer value to “0.” The fourth pointer value of the high-order bit pointer 62 is incremented (step S19).

Whenever the fourth pointer value is incremented, it is determined whether the fourth pointer value exceeds the second threshold value (step S20). When it is determined that the fourth pointer value does not exceed the second threshold value (No route of step S20), a subsequent read instruction is awaited and the process proceeds to step S15.

By incrementing the fourth pointer value, the read target buffer 5-1 is switched to the buffer 5-2 corresponding to the fourth pointer value “01.” Accordingly, the data written on the buffer 5-2 is read via the read path 6B by the selector 63a to which the control signal is input by the decoder 63b (see (5) of FIG. 6).

When the third pointer value exceeds the first threshold value and the buffer 5-2 enters a state in which the data is read up to the final data storage region, all of the bits of the third pointer value are reset to “0” and the fourth pointer value is incremented. By incrementing the fourth pointer value, the read target buffer 5-2 is switched to the buffer 5-3 corresponding to the second pointer value “10.” Accordingly, the data written on the buffer 5-3 is read via the read path 6C by the selector 63a to which the control signal is input by the decoder 63b (see (6) of FIG. 6).

When the third pointer value exceeds the first threshold value and the buffer 5-3 enters a state in which the data is read up to the final data storage region, all of the bits of the third pointer value are reset to “0” and the fourth pointer value is incremented to become “11.” At this time, when the fourth pointer value exceeds the second threshold value (Yes route of step S20), the fourth pointer value is reset to “00” by the high-order bit pointer 62 (step S21) and the write target buffer 5-3 is switched to the buffer 5-1. Accordingly, the data written on the buffer 5-1 is read via the read path 6A by the selector 63a to which the control signal is input by the decoder 63b (see (4) of FIG. 6).

As described above, the read target buffers 5 are switched according to the change in the third and fourth pointer values by the output controller 6 and the data written on the joint buffers 50 is read via the corresponding read paths 6A to 6C to be output to the output port 7.

The buffer device 2 having the above-described configuration as an example of this embodiment includes the input controller 4 and the output controller 6 which are buffer control devices. Thus, the buffer device 2 can assign the joint buffers 50 to the specific input port 3 merely setting the input controller 4 and the output controller 6 to perform the joint operation. That is, the buffer device 2 can select the input data from the plurality of input ports 3 and easily switch the buffer structure for output of data to the output path 7 to one FIFO structure.

That is, by providing the switch mechanism configured by the input controller 4 and the output controller 6 in the buffer device including the plurality of input ports 3 and at least one output port 7, one-to-one transmission of longer distance can be realized compared to the related art. Accordingly, in the buffer device 2 as an example of this embodiment, the buffer capacity of the buffer device 2, for example, the buffer capacity used for long distance transmission can be easily ensured with a simple configuration and convenient control by providing the simple switch mechanism of the input and output ports. Therefore, single-input and single-output data transmission of longer distance compared to the related art can be achieved.

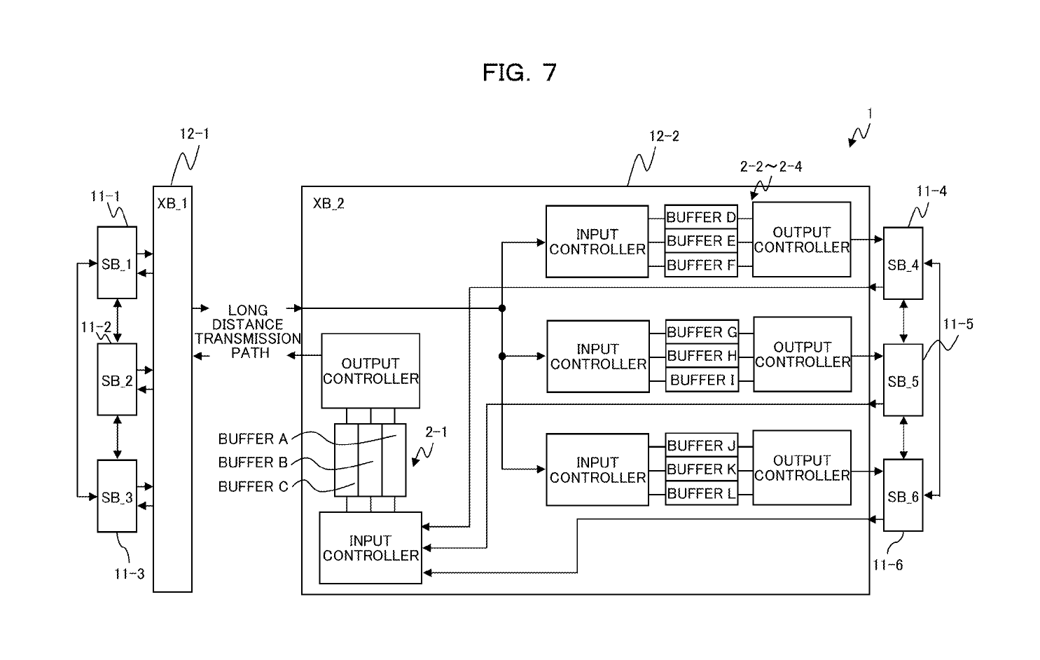

For example, the buffer device 2 can be provided in an XB or the like in an information processing system 1 exemplified in FIG. 7.

FIG. 7 is a diagram illustrating an example of the configuration of the information processing system 1 according to the embodiment. Note that, in FIG. 7, directions of arrows indicate transmission directions of data. In FIG. 7, the internal configuration of an XB 12-1 and parts of the configurations of buffer devices 2-1 to 2-4 of an XB 12-2 are not illustrated to simplify the drawing.

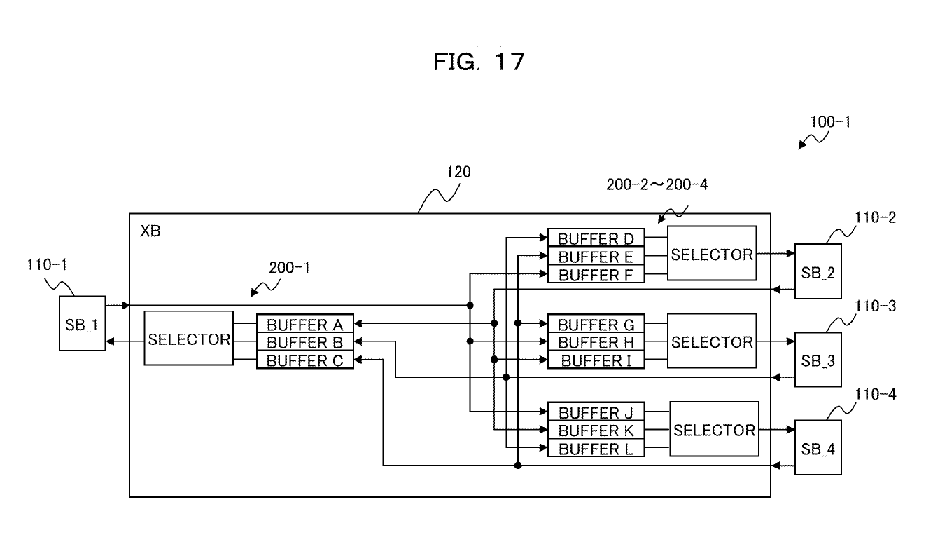

The XB 120 described above with reference to FIG. 17 is configured in many cases as a dedicated chip in which the input ports 300-1 to 300-3 and the buffers 500-1 to 500-3 of the buffer devices 200-1 to 200-4 correspond to each other in advance.

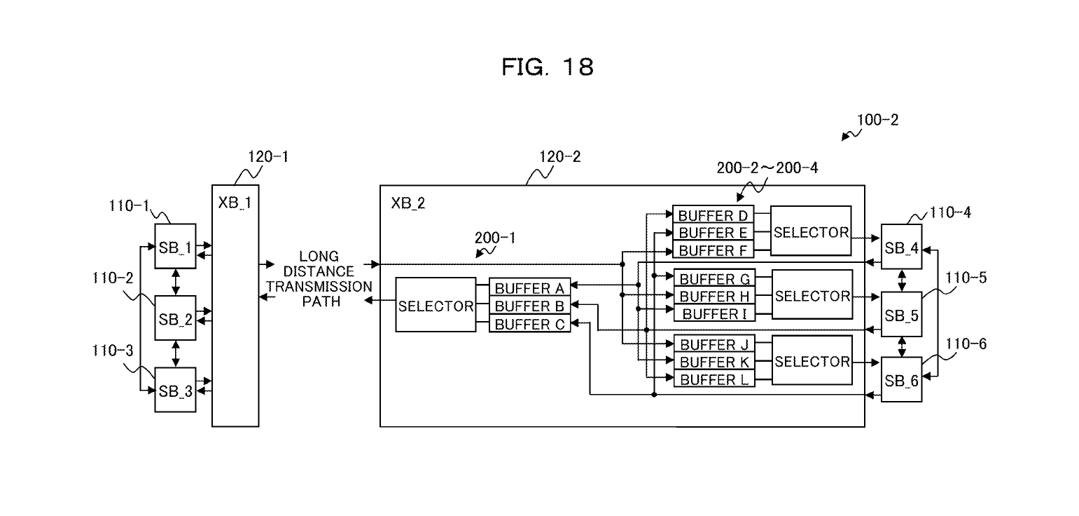

The XB 120-1 and the XB 120-2 described above with reference to FIG. 18 have the same configuration as the XB 120 illustrated in FIG. 17. However, the SB 110-4 to SB 110-6 illustrated in FIG. 18 are connected so as to communicate with each other without passing through the buffer devices 200-2 to 200-4. That is, the communication between the SB 110-1 to SB 110-3 and the communication between the SB 110-4 to SB 110-6 are performed without passing through each of the XB 120-1 and XB 120-2. However, the communication between a group of the SB 110-1 to SB 110-3 and a group of the SB 110-4 to SB 110-6 far distant from each other is performed via the XB 120-1 and the XB 120-2.

Accordingly, the buffers D, E, G, I, K, and L of the buffer devices 200-2 to 200-4 illustrated in FIG. 18 become unused buffers in the XB 120-1 and the XB 120-2.

In recent years, common use of components has been promoted even in the fields of information processing systems, for example, for the purpose of cost reduction. For example, there is a demand for desiring to use the same XB chip in both of the configurations of the information processing systems 100-1 and 100-2 described above with reference to FIGS. 17 and 18.

In the buffer device 2 as an example of this embodiment, a large scale integration (LSI) such as an XB chip having a buffer structure optimized for only a given specific configuration can be configured to have a proper buffer structure according to a configuration, for example, as illustrated in FIG. 7.

For example, the information processing system 1 as an example of this embodiment exemplified in FIG. 7 includes an SB 11-1 to an SB 11-6, the XB 12-1, and the XB 12-2 that have the same connection relation as the information processing system 100-2 exemplified in FIG. 18.

The XB 12-2 includes buffer devices 2-1 to 2-4 each corresponding to the buffer device 2 according to this embodiment. Further, the XB 12-1 has the same configuration as the XB 12-2, although not illustrated in FIG. 7.

As illustrated in FIG. 7, the output side of the buffer device 2-1 in the XB 12-2, that is, the output port 7 (not illustrated), is connected to the XB 12-1 via the long distance transmission path. The output sides of the buffer devices 2-2 to 2-4 are connected to the SB 11-4 to SB 11-6, respectively. On the other hand, the input sides of the buffer device 2-1 in the XB 12-2, that is, the input ports 3-1 to 3-3 (not illustrated) are connected to the SB 11-4 to SB 11-6, respectively. The input side of each of the buffer devices 2-2 to 2-4 is connected to the XB 12-1 via a long distance transmission path.

That is, as exemplified in FIG. 7, the buffer device 2-2 can write the data input from the XB 12-1 via the long distance transmission path and the specific input port 3 on the buffers D to F that form the joint buffers 50. Likewise, the buffer devices 2-3 and 2-4 can write the data input from the XB 12-1 via the long distance transmission path and the specific input port 3 on the buffers G to I and the buffers J to L that form the joint buffers 50, respectively.

As described with reference to FIG. 7, by using the buffer device 2 according to this embodiment, for example, the control can be performed by the same XB chip in both of the information processing systems 100-1 and 100-2 described above with reference to FIGS. 17 and 18. Accordingly, according to the buffer device 2 of this embodiment, the LSI can be used in more general in the information processing system, compared to the related art, with a simple configuration and convenient control. That is, the buffer device 2 according to this embodiment is particularly effective when an XB chip having a versatile configuration is applied.

In the input switch unit 40 and the output switch unit 60 of the buffer device 2 according to this embodiment, the write position and the read position of the data on and from the buffer 5 are positions indicated by the first and third pointer values retained in the low-order bit pointers 41 and 61. The write target and read target buffers 5 are selected according to the second and fourth pointer values retained by the high-order bit pointers 42 and 62. The first switch unit 43 switches the write target buffer 5 to another buffer 5 among the joint buffers 50 according to the information indicating the write position. Further, the second switch unit 63 can switch the read target buffer 5 to another buffer 5 among the joint buffers 50.

Accordingly, in the joint operation, by including only the low-order bit pointers 41 and 61, the high-order bit pointers 42 and 62, and the first and second switch units 43 and 63, the data can be written on or read from the joint buffers 50 formed by joining a plurality of buffers 5 with a simple configuration.

The low-order bit pointers 41 and 61 can be diverted from the write control pointer 5a and the read control pointer 5b provided in correspondence with one buffer 5 among the joint buffers 50.

Accordingly, since the low-order bit pointers 41 and 61 may be omissible, the manufacturing cost of the buffer device 2 can be reduced.

In the input setting unit 46 of the buffer device 2 according to this embodiment, the set register 47 retains the information indicating the specific input port 3 assigned to the joint buffers 50 and the selection unit 48 outputs the data input from the specific input port 3 among the plurality of input ports 3 to the input switch unit 40.

Accordingly, the input port 3 assigned to the joint buffers 50 can be determined through the simple control merely by setting the information indicating the specific input port 3 in the set register 47.

Further, the buffers 5 that form the joint buffers 50 and the input port 3 assigned to the joint buffers 50 can be set and updated by the firmware that monitors the buffer device 2.

Accordingly, even when the connection topology of the information processing system 1 or the like to which the buffer device 2 is applied is changed, the system configuration can be changed flexibly by changing the setting of the joint buffers 50 and the specific input port 3 by the firmware. Further, even while the information processing system 1 or the like to which the buffer device 2 is applied operates, the setting can be dynamically changed without shutdown of the system.

### [2] Modification Examples

The buffer device 2 having the above-described configuration as an example of the embodiment can be caused to function as a reception buffer that performs single-input and single-output using one specific input port 3 in the joint operation.

Data can be considered to be transmitted using the number of input ports 3 less than the number of input ports of the normal operation, among the input ports 3 of the buffer device 2 depending on the configuration of the information processing system 1, that is, the connection topology.

That is, in the above-described buffer device 2, the firmware is configured to select the execution of the normal operation using all of the input ports 3 or the execution of the joint operation using only one input port 3 depending on the connection topology. On the other hand, when some of the input ports 3 and the buffers 5 are not used, the firmware selects the execution of the normal operation without using some of the input ports 3 and the buffers 5 in the above-described buffer device 2.

A buffer device 2 according to this modification example can function as a reception buffer that performs m-input and single-output by logically joining a plurality of buffers 5, even when m, the number of input ports 3 and buffers 5, less than n, the number of input ports 3 of the buffer device 2 are used. Hereinafter, an operation in which the m-input and single-output is performed is referred to as a mixture operation.

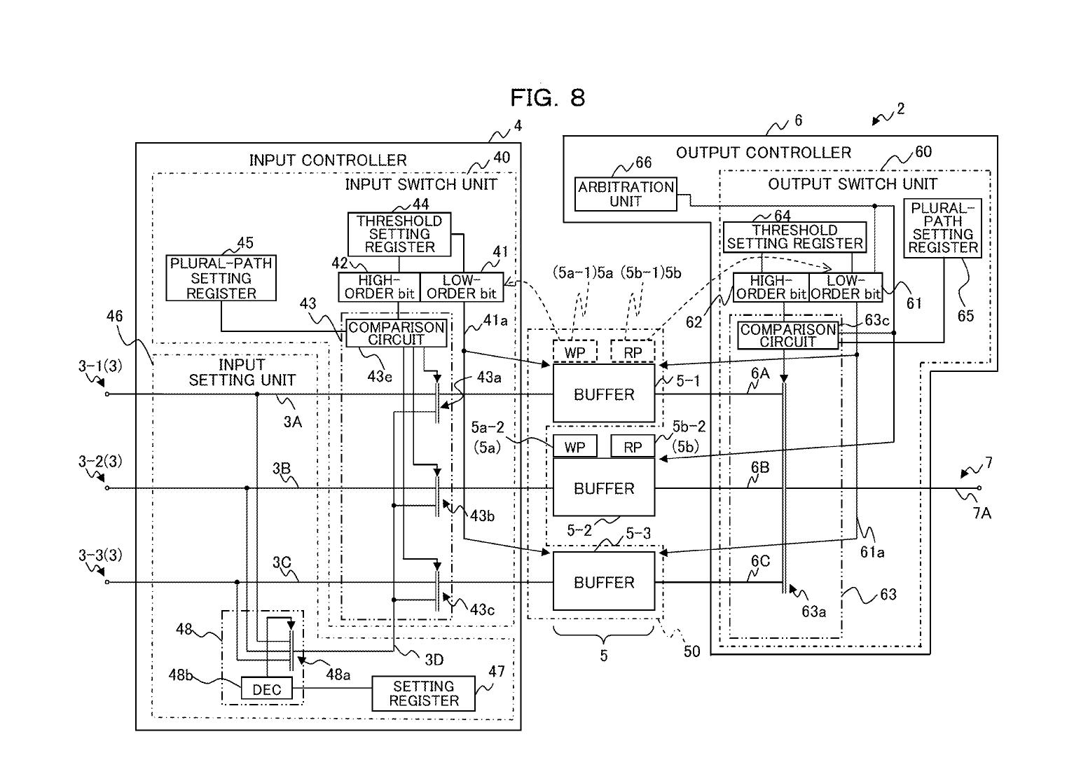

Hereinafter, the buffer device 2 according to this modification example will be described with reference to FIGS. 8 to 14.

FIG. 8 is a diagram illustrating the configuration of the buffer device 2 according to a modification example of an embodiment.

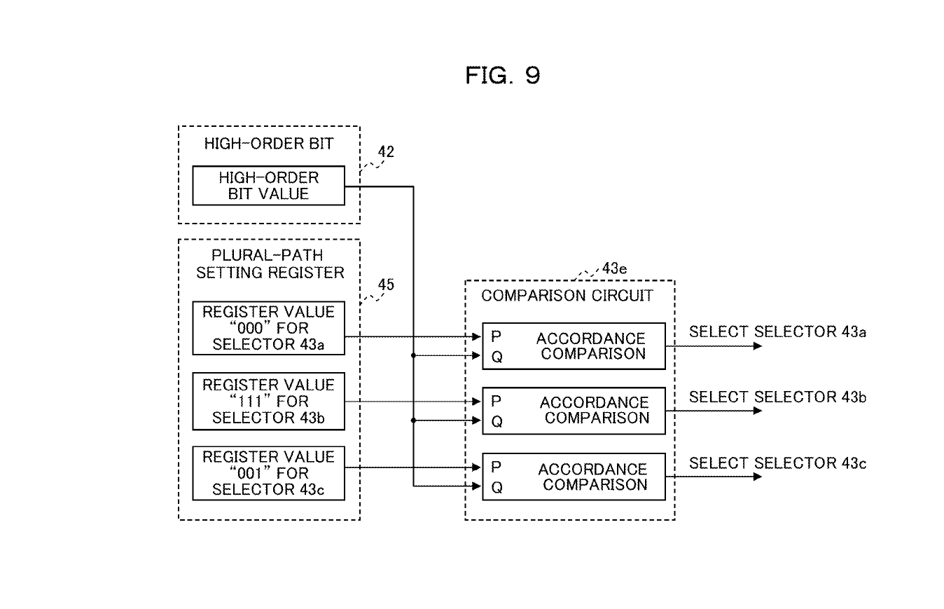

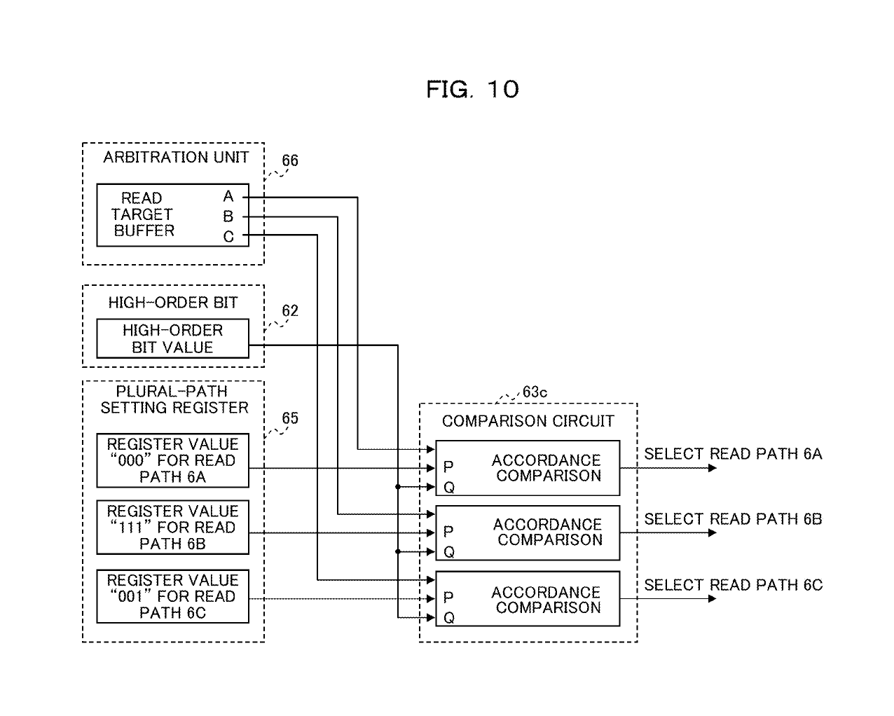

FIGS. 9 and 10 are diagrams illustrating an example of path selection in comparison circuits 43e and 63c of the buffer device 2 according to the modification example.

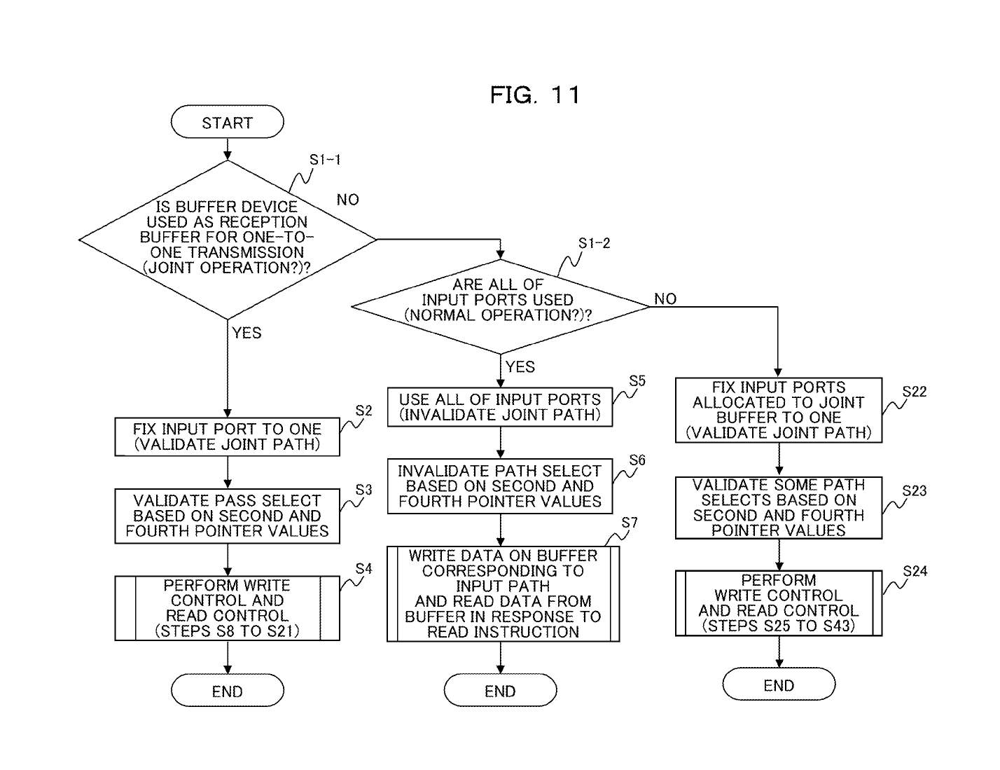

FIG. 11 is a flowchart illustrating an initial setting order of a normal operation, a joint operation, and a mixture operation performed by the buffer device 2 according to the modification example.

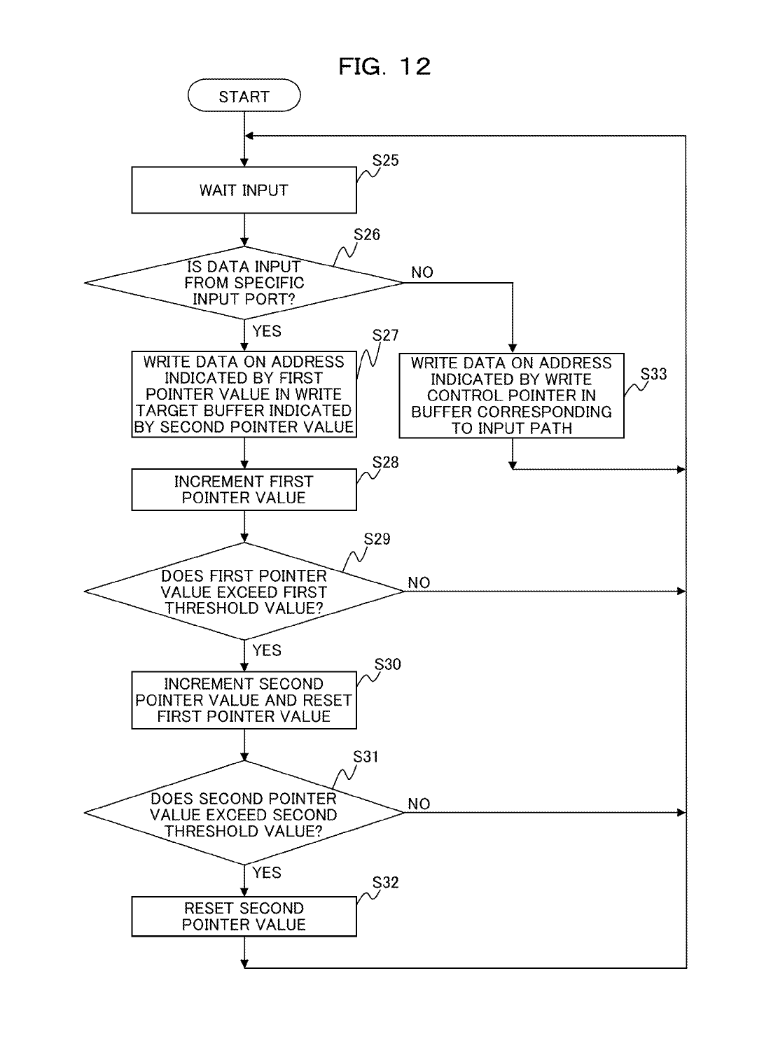

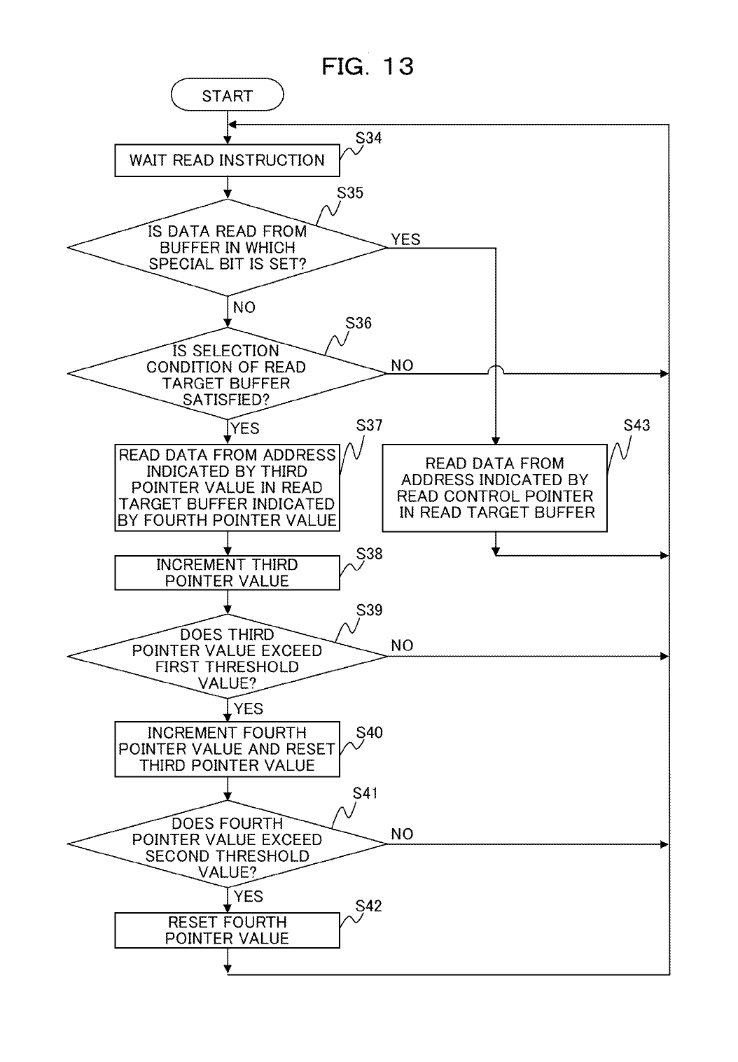

FIG. 12 is a flowchart illustrating an example of a process in the mixture operation performed by the input controller 4 of the buffer device 2 according to the modification example. FIG. 13 is a flowchart illustrating an example of a process in the mixture operation performed by the output controller 6 of the buffer device 2 according to the modification example.

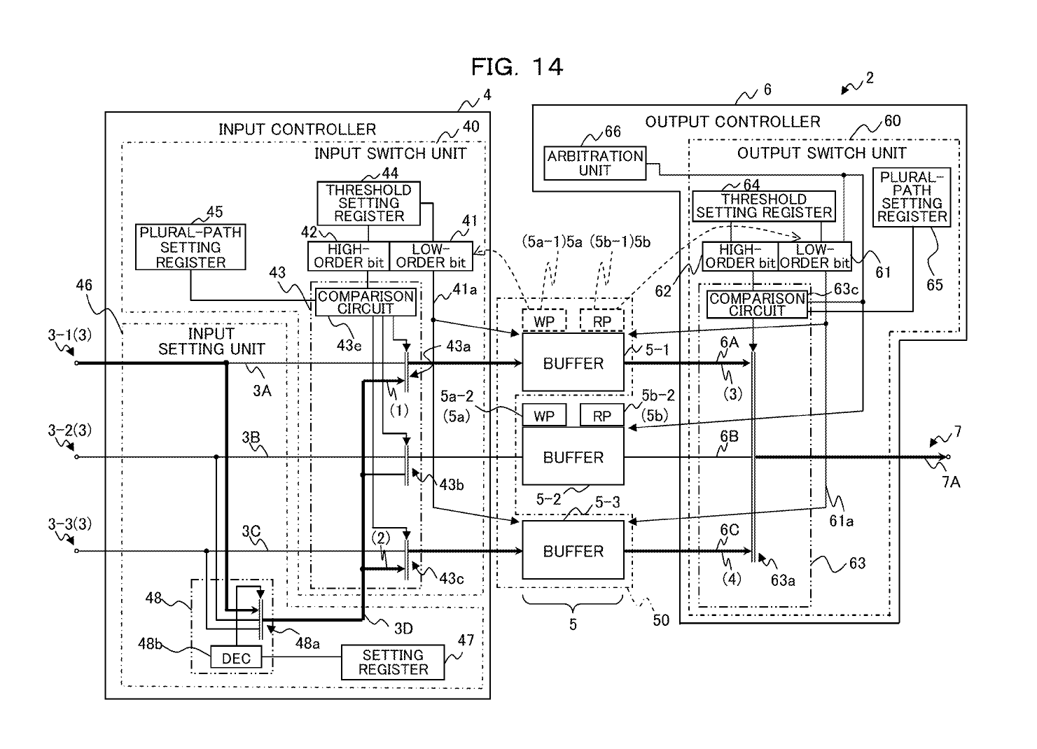

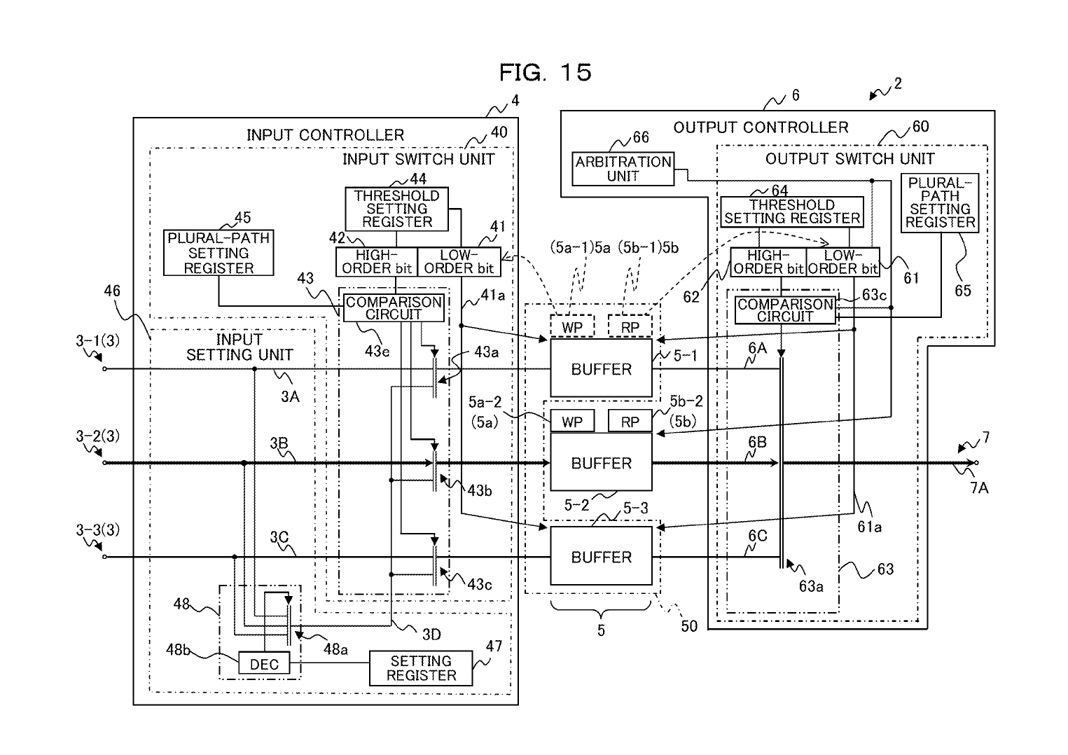

FIGS. 14 and 15 are diagrams illustrating an example of a process in the mixture operation of the buffer device 2 illustrated in FIG. 8.

First, an example of the configuration of the buffer device 2 according to this modification example illustrated in FIG. 8 will be described.

In the buffer device 2 according to this modification example, an input controller 4 selectively writes data input from an input port 3-1 on buffers 5-1 and 5-3 without using an input port 3-3 and writes data input from an input port 3-2 on a buffer 5-2 as in a normal operation.

That is, joint buffers 50 are formed by the buffers 5-1 and 5-3.

In the buffer device 2 according to this modification example, the output controller 6 reads data selectively from the buffers 5-1 and 5-3 that form the joint buffers 50 and the buffer 5-2, and outputs the data to the output port 7.

An input switch unit 40 of the input controller 4 includes a plural-path set register 45. A first switch unit 43 includes a comparison circuit 43e instead of the decoder 43d.

An output switch unit 60 of the output controller 6 includes a plural-path set register 65. A second switch unit 63 includes a comparison circuit 63c instead of the decoder 63b.

In the mixture operation, an arbitration unit 66 according to this modification example outputs a read instruction designating a read target buffer 5 to the output switch unit 60. That is, as in the arbitration unit 66 of the buffer device 2 in the normal operation illustrated in FIG. 2, the arbitration unit 66 according to this modification example outputs (issues) an instruction to read the data written on the selected read target buffer 5 to the output switch unit 60 at each read timing of the data from the buffer 5.

The buffer device 2 according to this modification example is different from the buffer device 2 illustrated in FIG. 2 in the above-described configuration. However, the remaining configuration is the same or substantially the same.

Note that, in practice, in FIG. 8, lines 41a and 61a used for the low-order bit pointers 41 and 61 to designate write and read positions of the buffers 5 that form the joint buffers 50 connect the low-order bit pointers 41 and 61 to the buffer 5-2, respectively, as in the buffer device 2 illustrated in FIG. 2. In this modification example, since the buffer 5-2 is not included in the joint buffers 50, lines 41a and 61a connecting the low-order bit pointers 41 and 61 to the buffer 5-2 are not illustrated to facilitate the description.

In practice, in FIG. 8, a line used for the arbitration unit 66 to increment a read control pointer 5b of the buffer 5 in the normal operation connects the arbitration unit 66 to each of the read control pointers 5b-1 and 5b-3. In this modification example, since the read control pointers 5b-1 and 5b-3 correspond to the buffers 5 that form the joint buffers 50, lines connecting the arbitration unit 66 to the read control pointers 5b-1 and 5b-3 are not illustrated to facilitate the description.

The plural-path set register 45 is a register that retains first buffer selection information corresponding to each of the buffers 5-1 to 5-3, that is, each of the selectors 43a to 43c.

The first buffer selection information indicates a correspondence relation between a second pointer value and the buffers 5-1 to 5-3 selected as a write target buffer 5, that is, the selectors 43a to 43c. The first buffer selection information is set by a firmware in the initial setting or the like of the mixture operation.

That is, the firmware can arbitrarily determine the order of the buffers 5 selected as the write target buffer 5 according to a register value set in the plural-path set register 45.

In this modification example, as illustrated in FIG. 9, register values are set in the first buffer selection information such that “000” is set as a second pointer value corresponding to the buffer 5-1, that is, the selector 43a, “111” is set as a second pointer value corresponding to the buffer 5-2, that is, the selector 43b, and “001” is set as a second pointer value corresponding to the buffer 5-3, that is, the selector 43c.

The comparison circuit 43e selects the buffer 5 corresponding to the first buffer selection information identical with the second pointer value of the high-order bit pointer 42 as the write target buffer 5.

That is, the comparison circuit 43e switches the write target buffer 5 according to the change in the second pointer value, as in the decoder 43d of the buffer device 2 illustrated in FIG. 2.

Here, the register value, “111,” caused to correspond to the selector 43b is special bits. A second threshold value is set such that the second threshold value is equal to or less than the value of the specific bits in a threshold value set register 44 by the firmware in the initial setting or the like of the mixture operation.

The buffer 5-2 not included in the joint buffers 50 is not designated by the second pointer value of the high-order bit pointer 42 in the mixture operation. That is, the comparison circuit 43e does not output a control signal used to select the data input via a joint bus 3D to the selector 43b corresponding to the buffer 5-2. In other words, in the joint operation, the comparison circuit 43e inhibits the buffer 5-2 corresponding to the selector 43b in which the special bits are set from being selected as the write target buffer 5 relevant to the data input from the specific input port 3-1.

In this modification example, as illustrated in FIG. 9, the second pointer value is “000” or “001” and the second threshold value is “001.” Accordingly, the comparison circuit 43e outputs a control signal used to select the joint path 3D to the selector 43a or 43c so that the buffer 5-1 or 5-3 is selected as the write target buffer 5 according to the change in the second pointer value.

On the other hand, the comparison circuit 43e outputs a control signal used to select the corresponding input paths 3A to 3C to the selector 43b in which the special bits are set in the first buffer selection information.

In the first buffer selection information retained by the plural-path set register 45, as described above, the special bits are set for the selectors 43a to 43c corresponding to the buffer 5 configured to perform the same input and output as the normal operation in the initial setting or the like of the mixture operation.

The plural-path set register 65 is a register that retains second buffer selection information corresponding to each of the buffers 5-1 to 5-3, that is, each of the read paths 6A to 6C.

The second buffer selection information indicates a correspondence relation between a fourth pointer value and the buffers 5-1 to 5-3 selected as a read target buffer 5, that is, the read paths 6A to 6C. The second buffer selection information is set by a firmware in the initial setting or the like of the mixture operation.

That is, the firmware can arbitrarily determine the order of the buffers 5 selected as the read target buffer 5 according to a register value set in the plural-path set register 65.

In this modification example, as in the first buffer selection information, as illustrated in FIG. 10, register values are set in the second buffer selection information such that “000” is set as a fourth pointer value corresponding to the buffer 5-1, that is, the read path 6A, “111” is set as a fourth pointer value corresponding to the buffer 5-2, that is, the read path 6B, and “001” is set as a fourth pointer value corresponding to the buffer 5-3, that is, the read path 6C.

When a read instruction in which the read target buffer 5 is designated from the arbitration unit 66 is input and the fourth pointer value of the high-order bit pointer 62 is identical with the second buffer selection information set in the read target buffer 5, a comparison circuit 63c outputs a control signal to the selector 63a so that the data is read from the read target buffer 5.

Here, the resister value, “111,” caused to correspond to the read path 6B is special bits. The second threshold value is set such that the second threshold value is equal to or less than the value of the special bits in the threshold value set register 64.

The buffer 5-2 not included in the joint buffers 50 is not designated by the fourth pointer value of the high-order bit pointer 62 in the mixture operation. That is, in this modification example, the second threshold value is “010” and the fourth threshold value is “000” or “001,” as illustrated in FIG. 10.

The comparison circuit 63c outputs a control signal used to select the read path 6A or 6C to the selector 63a so that the buffer 5-1 or 5-3 is selected as a read target buffer 5 according to the read instruction from the arbitration unit 66 and the change in the fourth pointer value.

On the other hand, when the buffer 5 corresponding to the read path 6B in which the special bits are set is selected as the read target buffer 5 in the read instruction input from the arbitration unit 66, the comparison circuit 63c outputs a control signal used to select the read path 6B to the selector 63a, irrespective of the fourth pointer value.

That is, when the buffer 5 that forms the joint buffers 50 is designated as the read target buffer 5 in the read instruction from the arbitration unit 66 and when the second buffer selection information is compared to the fourth pointer value and is identical with the fourth pointer value, the comparison circuit 63c outputs a control signal used to read the data from the read target buffer 5 to the selector 63a. On the other hand, when the buffer 5 other than the joint buffers 50 is designated as the read target buffer 5 in the read instruction from the arbitration unit 66, the comparison circuit 63c outputs a control signal used to read the data from the read target buffer 5 to the selector 63a without comparing the second buffer selection information with the fourth pointer value.

Next, an example of a process of the buffer device 2 according to this modification example will be described with reference to FIGS. 11 to 14.

In the example of the process illustrated in FIG. 11, step S1-2 and step S22 to step S24 are newly added to the example of the process illustrated in FIG. 3. Note that, since Yes route of step S1-1, Yes route of step S1-2, and the processes of step S2 to step S5 are the same as those of the example of the process illustrated in FIG. 3, the detailed description will not be made.

First, when the firmware determines in step S1-1 that the buffer device 2 is not used as a reception buffer for one-to-one transmission (No route of step S1-1), the firmware determines whether all of the input ports 3 are used, that is, the normal operation is performed (step S1-2).

When the firmware determines that all of the input ports 3 are not used (No route of step S1-2), the firmware specifies the input port 3 to which the data to be written on the joint buffers 50 is input in the case in which the buffer device 2 performs the m-input and single-output as the initial setting of the mixture operation. Then, the firmware sets information indicating the specific input port 3 in the set register 47 so that the specific input port 3 is fixedly used at the time of the writing on the joint buffers 50 (step S22). That is, the firmware validates the joint path 3D that outputs the data input from the specific input port 3 to the input switch unit 40.

Subsequently, the firmware sets valid/invalid flags of the input controller 4 and the output controller 6 such that the valid/invalid flags are valid (step S23). That is, the path selection based on the second and fourth pointer values by the comparison circuits 43e and 63c, that is, the selection of the selectors 43a to 43c based on the second pointer value and the selection of the read paths 6A to 6C based on the fourth pointer value, is validated.

Note that, when the write control pointer 5a and the read control pointer 5b are diverted as the lower-order bit pointers 41 and 61, the firmware validates the setting such that the diverted write control pointer 5a and the diverted read control pointer 5b are used as the lower-order bit pointers 41 and 61. Further, the firmware invalidates the write control pointers 5a and the read control pointers 5b which are provided in correspondence with the buffers 5 that form the joint buffers 50 and are not diverted.

In step S23, in the plural-path set registers 45 and 65, the special bits of a value not designated by the second and fourth pointer values can be caused to correspond to the buffer 5 that does not form the joint buffers 50.

The second threshold value equal to or less than the value of the special bits is set in the threshold value set registers 45 and 65.

When the process of step S23 is performed, the mixture operation is performed in the buffer device 2, and thus write control of the data input from the specific input port 3 on the joint buffers 50 is performed and write control of the data input from the input port 3 other than the specific input port 3 on the corresponding buffer 5 is performed. Further, read control of the data from the joint buffers 50 and the buffer 5 other than the joint buffers 50 is performed (step S24).

Next, an example of a process in the mixture operation performed by the input controller 4 of the buffer device 2 according to this embodiment will be described with reference to FIGS. 12, 14, and 15.

Hereinafter, a case will be described in which the buffer device 2 illustrated in FIGS. 14 and 15 has completed the processes of step S22 and step S23 of FIG. 11 and the mixture operation of step S24 is performed using the input port 3-1 as the specific input port 3 and the input port 3-2 as the input port 3 that performs the normal input and output. The description will be made assuming that the first and second buffer selection information of the plural-path set registers 45 and 65 illustrated in FIGS. 9 and 10 is set in the buffers 5-1 to 5-3 and the second threshold value, “001,” is set in the threshold value set registers 44 and 64.

As illustrated in FIG. 12, first, the input controller 4 awaits input of the data from the input ports 3 (step S25).

When the data is input from the specific input port 3-1 (Yes route of step S26), the input controller 4 writes the data at an address position indicated by the first pointer value of the low-order bit pointer 41 in the write target buffer 5 indicated by the second pointer value of the high-order bit pointer 42 (step S27).

In the example illustrated in FIG. 14, when the second pointer value is “000,” the comparison circuit 43e outputs a control signal used to select the joint path 3D to the selector 43a corresponding to the second pointer value “000.” Then, the data input from the input port 3-1 via the joint path 3D is written at the address position indicated by the first pointer value in the corresponding buffer 5-1 via the selector 43a (see (1) of FIG. 14).

When the second pointer value is “001,” the comparison circuit 43e outputs a control signal used to select the joint path 3D to the selector 43c corresponding to the second pointer value “001.” Then, the data input from the input port 3-1 via the joint path 3D is written at the address position indicated by the first pointer value in the corresponding buffer 5-3 via the selector 43c (see (2) of FIG. 14).

Note that, since the processes of step S28 to step S32 are the same as the processes of step S10 to step S14 of FIG. 4, the detailed description will not be made.

On the other hand, when the data is input from the input port 3-2 (No route of step S26), the comparison circuit 43e inputs a control signal used to select the input path 3B to the selector 43b. Accordingly, as illustrated in FIG. 15, the data input from the input port 3-2 via the input path 3B is written at the address position indicated by the pointer value of the write control pointer 5a-2 of the buffer 5-2 via the selector 43b (step S33).

As described with reference to FIGS. 12, 14, and 15, the write target buffer 5 is switched according to the change in the first and second pointer values by the first switch unit 43 and the data input from the input port 3-1 to the first switch unit 43 via the joint path 3D is written on the joint buffers 50. Further, the data input from the input port 3-2 to the first switch unit 43 via the input path 3B is written on the corresponding buffer 5 by the first switch unit 43.

Next, an example of the process in the mixture operation performed by the output controller 6 of the buffer device 2 according to this embodiment will be described with reference to FIGS. 13 to 15.

As illustrated in FIG. 13, first, the output switch unit 60 awaits the read instruction from the arbitration unit 66 (step S34). When the read instruction is input to the output switch unit 60, the output controller 6 determines whether the read instruction is the read instruction from the buffer 5 in which the special bits are set. That is, the output controller 6 determines whether the read target buffer 5 designated in the read instruction is the buffer 5 corresponding to the read paths 6A to 6C in which the special bits are set in the plural-path set register 65 (step S35).

When the read instruction is not the read instruction from the buffer 5 in which the special bits are set (No route of step S35), the comparison circuit 63c determines whether a condition in which the data is read from the read target buffer 5 designated by the read instruction is satisfied (step S36). Specifically, in step S36, the comparison circuit 63c determines whether the register value of the second buffer selection information corresponding the read target buffer 5 designated by the read instruction is identical with the fourth pointer value of the high-order bit pointer 62.

When the condition is not satisfied (No route of step S36), a subsequent read instruction is awaited and the process proceeds to step S34.

Conversely, when the condition is satisfied (Yes route of step S36), the data is read from the address position indicated by the third pointer value of the low-order bit pointer 61 in the read target buffer 5 indicated by the fourth pointer value of the high-order bit pointer 62 (step S37).

In the example illustrated in FIG. 14, when the fourth pointer value is “000,” the comparison circuit 63c outputs a control signal used to select the read path 6A corresponding to the fourth pointer value, “000,” to the selector 63a. Then, the data written on the buffer 5-1 is read from the address position indicated by the third pointer value via the read path 6A and is output to the output port 7 by the selector 63a (see (3) of FIG. 14).

When the fourth pointer value “001,” the comparison circuit 63c outputs a control signal used to select the read path 6C corresponding to the fourth pointer value “001,” to the selector 63a. Then, the data written on the buffer 5-3 is read from the address position indicated by the third pointer value via the read path 6C and is output to the output port 7 by the selector 63a (see (4) of FIG. 14).

Note that, since the processes of step S38 to step S42 are the same as the processes of step S17 to step S21 of FIG. 5, the detailed description will not be made.

On the other hand, when the read instruction is the read instruction from the buffer 5 in which the special bits are set, for example, the buffer 5-2 (Yes route of step S35), the output controller 6 reads the data from the address position indicated by the read control pointer 5b-2 in the read target buffer 5-2 via the read path 3B and outputs the data to the output port (step S33).

That is, in step S33, the data written on the buffer 5-2 is read via the read path 6B by the selector 63a to which the control signal by the comparison circuit 63c is input.

As described with reference to FIGS. 13 to 15, the read target buffer 5 is switched according to the read instruction and the change in the third and fourth pointer values by the output controller 6, and the data written on the joint buffers 50 is read via the corresponding read path 6A or 6C and is output to the output port 7. Further, the data written on the buffer 5-2 other than the joint buffers 50 is selected according to the read instruction and is read via the corresponding read path 6B, and then is output to the output port 7 by the output controller 6.

Note that, in this modification example, the case has been described in which the input port 3 performing the normal input and output is one (input port 3-2) other than the input port 3-1 corresponding to the joint buffers 50, but the invention is not limited thereto. The buffers 5 in which the special bits are set in the plural-path set register 45, that is, the number of selectors may be, for example, two or more according to the number of input ports 3 to be used.

By the special bits set in the register value, a combination of the specific input port 3 using the joint buffers 50 and the unused input port 3 may be realized other than the combination of the input ports 3 illustrated in FIGS. 9, 10, 14, and 15.

In the buffer device 2 having the above-described configuration according to this modification example illustrated in FIG. 8, it is possible to obtain the same advantages as the buffer device 2 according to the embodiment illustrated in FIG. 2.

In the initial setting or the like of the mixture operation, the firmware ensures the buffer capacity for the data input via the specific input port 3 by setting the special bits in the plural-path set registers 45 and 65 with regard to the buffer 5 which does not form the joint buffers 5, and then causes another input port 3 for which the data is not written on the joint buffers 50 to use the corresponding buffer 5. That is, by realizing a simple configuration in which the plural-path set registers 45 and 65 and the comparison circuits 43e and 63c instead of the decoders 43d and 63b are included in the buffer device 2 illustrated in FIG. 2, the reception buffer 2 performing the m-input and single-output can be realized.

In the buffer device 2 according to this modification example illustrated in FIG. 8, it is possible to realize the mixture operation in which the m-input and single-output is performed. Further, it is possible to realize the joint operation in which the single-input and single-output is performed, as described above with reference to FIGS. 4 and 5, and the normal operation in which the multi-input and single-output is performed, as in the related art.

Accordingly, the buffer device 2 according to this modification example can be realized as a more generally used reception buffer with a simple configuration and convenient control, since the plurality of operation forms can be switched.

### [3] Others

The preferred embodiment and the modification example of the invention have been described in detail. However, the invention is not limited to specific embodiments and modification examples, but may be modified and changed in various ways within the scope of the invention without departing from the gist of the invention.

For example, the description has been made assuming that the number of bits of the second and fourth pointer values in the buffer device 2 according to the embodiment is two bits and the number of bits of the second and fourth pointer values in the buffer device 2 according to the modification example is three bits, but the invention is not limited thereto. That is, the number of bits of the second and fourth pointer values can increase or decrease arbitrarily according to the number of input ports 3, that is, the number of buffers 5 that form the joint buffers 50.

The case has been described in which the buffer device 2 according to the embodiment and the modification example includes the three input ports 3, the three input paths 3A to 3C, and the three buffers 5, but the invention is not limited thereto. Any numbers of input ports, input paths, and buffers may be used according to the configuration of the buffer device 2.

In the buffer device 2 according to the embodiment and the modification example, the write control pointer 5a-1 and the read control pointer 5b-1 included in the buffer 5-1 are diverted as the low-order bit pointers 41 and 61, but the invention is not limited thereto. When the write control pointer 5a and the read control pointer 5b included in the buffer 5 are diverted as the low-order bit pointers 41 and 61, the write control pointer 5a and the read control pointer 5b included in any buffer 5 among the buffers 5 that form the joint buffers 50 may be used.

According to the technology of the disclosure, a buffer capacity in the buffer device can be ensured with ease with a simple configuration.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A buffer device comprising:
a plurality of input ports;
a plurality of buffers on which information input from the plurality of input ports is written, respectively, and each of the plurality of buffers is a first in, first out (FIFO) buffer;
at least one output port from which information read from the buffers is output;
an input switch unit that writes input information on a write target buffer selected from a predetermined buffer group based on information indicating a write position in the buffers of the buffer group and switches the write target buffer to another buffer in the buffer group according to the information indicating the write position, when the information is input from the input ports allocated to the buffer group among the plurality of buffers; and
an output controller that reads information from a read target buffer selected based on information indicating a read position in the buffers of the buffer group and outputs the read information to the output port, and
the input switch unit includes
a first pointer that retains a first pointer value indicating the write position;
a second pointer that retains a second pointer value changed according to the first pointer value; and
a first switch unit that switches the write target buffer to the other buffer according to the change in the second pointer value and writes the information input from the input port on the write position indicated by the first pointer value in the switched write target buffer.

2. The buffer device according to claim 1, wherein
the first pointer changes the first pointer value when the information input from the input port is written on the write target buffer, and resets the first pointer value when the first pointer value exceeds a first threshold value, and
the second pointer changes the second pointer value when the first pointer value exceeds the first threshold value, and resets the second pointer value when the second pointer value exceeds a second threshold value.

3. The buffer device according to claim 1, wherein the first pointer is a write control pointer provided in correspondence with one buffer in the buffer group.

4. The buffer device according to claim 1, wherein
the input switch unit further includes a first register that retains first buffer selection information corresponding to each of the plurality of buffers, and
the first switch unit selects a buffer corresponding to the first buffer selection information identical with the second pointer value as the write target buffer.

5. The buffer device according to claim 4, wherein the first switch unit inhibits a buffer other than the buffer group from being selected as the write target buffer and writes information input from the input port corresponding to the buffer other than the buffer group on the buffer other than the buffer group.

6. The buffer device according to claim 1, further comprising:
an input setting unit that outputs the input information to the input switch units, when information is input from the input ports allocated to the buffer group,
wherein the input switch unit writes the information input from the input setting unit on the write target buffer based on the write position.

7. The buffer device according to claim 6, wherein the input setting unit includes
a second register that retains information indicating the input ports allocated to the buffer group, and
a selection unit that selects the input ports allocated to the buffer group from the plurality of input ports based on the information retained in the second register and outputs the information input from the selected input port to the input switch unit.

8. The buffer device according to claim 6, wherein the information input from the input port corresponding to the buffer other than the buffer group is input to the input switch unit without passing through the selection unit and is written on the corresponding buffer other than the buffer group.

9. The buffer device according to claim 1, wherein the output controller includes
an output switch unit that reads the information from the read target buffer and outputs the information to the output port and that switches the read target buffer to another buffer in the buffer group according to the information indicating the read position.

10. The buffer device according to claim 9, wherein the output switch unit includes
a third pointer that retains a third pointer value indicating the read position,
a fourth pointer that retains a fourth pointer value changed according to the third pointer value, and
a second switch unit that switches the read target buffer to the other buffer according to the change in the fourth pointer value and reads information from the read position indicated by the third pointer value in the switched read target buffer.

11. The buffer device according to claim 10, wherein
the third pointer changes the third pointer value when the information is read from the read target buffer of the buffer group, and resets the third pointer value when the third pointer value exceeds a first threshold value, and
the fourth pointer changes the fourth pointer value when the third pointer value exceeds the first threshold value, and resets the fourth pointer value when the fourth pointer value exceeds a second threshold value.

12. The buffer device according to claim 11, wherein
the output controller further includes an arbitration unit that issues a read instruction to read the information written on the plurality of buffers,
the output switch unit reads the information from the read target buffer according to the read instruction issued from the arbitration unit, and
the third pointer changes the third pointer value, when the read instruction is issued from the arbitration unit.

13. The buffer device according to claim 12, wherein
the output switch unit further includes a third register that retains second buffer selection information corresponding to each of the plurality of buffers, and
the second switch unit selects a buffer corresponding to the second buffer selection information identical with the fourth pointer value as the read target buffer.

14. The buffer device according to claim 13, wherein, when data is input from two or more input ports among the plurality of input ports,
the second switch unit selects the buffer designated by the read instruction as the read target buffer when the read instruction issued from the arbitration unit is a read instruction to read the information written on the buffer group and the second buffer selection information corresponding to the buffer designated by the read instruction is identical with the fourth pointer value, whereas when the read instruction issued from the arbitration unit is a read instruction to read the information written on the buffer other than the buffer group, the second switch unit selects the buffer other than the buffer group designated by the read instruction as the read target buffer.

15. The buffer device according to claim 10, wherein the third pointer is a read control pointer provided in correspondence with one buffer in the buffer group.

16. The buffer device according to claim 1, wherein the buffers constituting the buffer group and the input ports allocated to the buffer group are set and updated by firmware monitoring the buffer device.

17. A buffer control device in a buffer device including a plurality of input ports, a plurality of buffers on which information input from the plurality of input ports is written, respectively, each of the plurality of buffers is a first in, first out (FIFO) buffer, and at least one output port from which information read from the buffers is output, the buffer control device comprising:
an input switch unit that writes input information on a write target buffer selected from a predetermined buffer group based on information indicating a write position in the buffers of the buffer group and switches the write target buffer to another buffer in the buffer group according to the information indicating the write position, when the information is input from the input ports allocated to the buffer group among the plurality of buffers; and
an output controller that reads information from a read target buffer selected based on information indicating a read position in the buffers of the buffer group and outputs the read information to the output port, and
the input switch unit includes
a first pointer that retains a first pointer value indicating the write position;
a second pointer that retains a second pointer value changed according to the first pointer value; and
a first switch unit that switches the write target buffer to the other buffer according to the change in the second pointer value and writes the information input from the input port on the write position indicated by the first pointer value in the switched write target buffer.

18. A buffer control method in a buffer device including a plurality of input ports, a plurality of buffers on which information input from the plurality of input ports is written, respectively, each of the plurality of buffers is a first in, first out (FIFO) buffer, and at least one output port from which information read from the buffers is output, the buffer control method comprising:
selecting a write target buffer from a predetermined buffer group based on information indicating a write position in the buffers of the buffer group, when the information is input from the input ports allocated to the buffer group among the plurality of buffers;
writing the input information on the selected write target buffer;
switching the write target buffer to another buffer in the buffer group according to the information indicating the write position;
selecting a read target buffer from the buffer group based on information indicating a read position in the buffers of the buffer group; and
reading information from the selected read target buffer and outputting the information to the output port, and
the buffer control method further comprises
changing, according to a first pointer value in a first pointer indicating the write position, a second pointer value retained in a second pointer;
switching the write target buffer to the other buffer according to the change in the second pointer value; and
writing the information input from the input port on the write position indicated by the first pointer value in the switched write target buffer.
